(19) United States
(12) Patent Application Publication
(10) Pub. No.: US 2006/0236063 A1
(43) Pub. Date: Oct. 19, 2006

(54) RDMA enabled I/O adapter performing efficient memory management

(75) Inventors: Brian S. Hausauer, Austin, TX (US); Robert O. Sharp, Round Rock, TX (US)

Correspondence Address: HUFFMAN LAW GROUP, P.C., 1832 N. CASCADE AVE., COLORADO SPRINGS, CO, 80907-7449, US

(73) Assignee: NetEffect, Inc., Austin, TX (US)

(21) Appl. No.: 11/357,446

(22) Filed: Feb. 17, 2006

Related U.S. Application Data
(60) Provisional application No. 60/666,757, filed on Mar. 30, 2005.

(51) Int. Cl. G06F 12/00

(52) U.S. Cl. 711/170

(57) ABSTRACT

An RDMA enabled I/O adapter and device driver is disclosed. In response to a memory registration that includes a list of physical memory pages backing a virtually contiguous memory region, an entry in a table in the adapter memory is allocated. A variable size data structure to store the physical addresses of the pages is also allocated as follows: if the pages are physically contiguous, the physical page address of the beginning page is stored directly in the table entry and no other allocations are made; otherwise, one small page table is allocated if the addresses will fit in a small page table; otherwise, one large page table is allocated if the addresses will fit in a large page table; otherwise, a page directory is allocated and enough page tables to store the addresses are allocated. The size and number of the small and large page tables is programmable.

### CROSS REFERENCE TO RELATED APPLICATION(S)

This application claims the benefit of U.S. Provisional Application No. 60/666,757 (Docket: BAN.0201), filed on Mar. 30, 2005, which is herein incorporated by reference for all intents and purposes.

### FIELD OF THE INVENTION

The present invention relates in general to I/O adapters, and particularly to memory management in I/O adapters.

### BACKGROUND OF THE INVENTION

Computer networking is now ubiquitous. Computing demands require ever-increasing amounts of data to be transferred between computers over computer networks in shorter amounts of time. Today, there are three predominant computer network interconnection fabrics. Virtually all server configurations have a local area network (LAN) fabric that is used to interconnect any number of client machines to the servers. The LAN fabric interconnects the client machines and allows the client machines access to the servers and perhaps also allows client and server access to network attached storage (NAS), if provided. The most commonly employed protocol in use today for a LAN fabric is TCP/IP over Ethernet. A second type of interconnection fabric is a storage area network (SAN) fabric, which provides for high speed access of block storage devices by the servers. The most commonly employed protocol in use today for a SAN fabric is Fibre Channel. A third type of interconnection fabric is a clustering network fabric. The clustering network fabric is provided to interconnect multiple servers to support such applications as high-performance computing, distributed databases, distributed data storage, grid computing, and server redundancy. Although it was hoped by some that INFINIBAND would become the predominant clustering protocol, this has not happened so far. Many clusters employ TCP/IP over Ethernet as their interconnection fabric, and many other clustering networks employ proprietary networking protocols and devices. A clustering network fabric is characterized by a need for super-fast transmission speed and low-latency.

It has been noted by many in the computing industry that a significant performance bottleneck associated with networking in the near term will not be the network fabric itself, as has been the case in the past. Rather, the bottleneck is now shifting to the processor in the computers themselves. More specifically, network transmissions will be limited by the amount of processing required of a central processing unit (CPU) to accomplish network protocol processing at high data transfer rates. Sources of CPU overhead include the processing operations required to perform reliable connection networking transport layer functions (e.g., TCP/IP), perform context switches between an application and its underlying operating system, and copy data between application buffers and operating system buffers.

It is readily apparent that processing overhead requirements must be offloaded from the processors and operating systems within a server configuration in order to alleviate the performance bottleneck associated with current and future networking fabrics. One way in which this has been accomplished is by providing a mechanism for an application program running on one computer to transfer data from its host memory across the network to the host memory of another computer. This operation is commonly referred to as a remote direct memory access (RDMA) operation. Advantageously, RDMA drastically eliminates the need for the operating system running on the server CPU to copy the data from application buffers to operating system buffers and vice versa. RDMA also drastically reduces the latency of an inter-host memory data transfer by reducing the amount of context switching between the operating system and application.

Two examples of protocols that employ RDMA operations are INFINIBAND and iWARP, each of which specifies an RDMA Write and an RDMA Read operation for transferring large amounts of data between computing nodes. The RDMA Write operation is performed by a source node transmitting one or more RDMA Write packets including payload data to the destination node. The RDMA Read operation is performed by a requesting node transmitting an RDMA Read Request packet to a responding node and the responding node transmitting one or more RDMA Read Response packets including payload data. Implementations and uses of RDMA operations are described in detail in the following documents, each of which is incorporated by reference in its entirety for all intents and purposes:
“InfiniBand™ Architecture Specification Volume 1, Release 1.2.” October 2004. InfiniBand Trade Association. (http://www.InfiniBandta.org/specs/register/publicspec/vol1r1_{—}2.zip)
Hilland et al. “RDMA Protocol Verbs Specification (Version 1.0).” April, 2003. RDMA Consortium. Portland, Oreg. (http://www.rdmaconsortium.org/home/draft-hilland-iwarp-verbs-v1.0-rdmac.pdf).
Recio et al. “An RDMA Protocol Specification (Version 1.0).” October 2002. RDMA Consortium. Portland, Oreg. (http://www.rdmaconsortium.org/home/draft-recio-iwarp-rdmap-v1.0.pdf).
Shah et al. “Direct Data Placement Over Reliable Transports (Version 1.0).” October 2002. RDMA Consortium. Portland, Oreg. (http://www.rdmaconsortium.org/home/draft-shah-iwarp-ddp-v1.0.pdf).
Culley et al. “Marker PDU Aligned Framing for TCP Specification (Version 1.0).” Oct. 25, 2002. RDMA Consortium. Portland, Oreg. (http://www.rdmaconsortium.org/home/draft-culley-iwarp-mpa-v1.0.pdf).

Essentially all commercially viable operating systems and processors today provide memory management. That is, the operating system allocates regions of the host memory to applications and to the operating system itself, and the operating system and processor control access by the applications and the operating system to the host memory regions based on the privileges and ownership characteristics of the memory regions. An aspect of memory management particularly relevant to RDMA is virtual memory capability. A virtual memory system provides several desirable features. One example of a benefit of virtual memory systems is that they enable programs to execute with a larger virtual memory space than the existing physical memory space. Another benefit is that virtual memory facilitates relocation of programs in different physical memory locations during different or multiple executions of the program. Another benefit of virtual memory is that it allows multiple processes to execute on the processor simultaneously, each having its own allocated physical memory pages to access without having to be swapped in from disk, and without having to dedicate the full physical memory to one process.

In a virtual memory system, the operating system and CPU enable application programs to address memory as a contiguous space, or region. The addresses used to identify locations in this contiguous space are referred to as virtual addresses. However, the underlying hardware must address the physical memory using physical addresses. Commonly, the hardware views the physical memory as pages. A common memory page size is 4 KB. Thus, a memory region is a set of memory locations that are virtually contiguous, but that may or may not be physically contiguous. As mentioned, the physical memory backing the virtual memory locations typically comprises one or more physical memory pages. Thus, for example, an application program may allocate from the operating system a buffer that is 64 KB, which the application program addresses as a virtually contiguous memory region using virtual addresses. However, the operating system may have actually allocated sixteen physically discontiguous 4 KB memory pages. Thus, each time the application program uses a virtual address to access the buffer, some piece of hardware must translate the virtual address to the proper physical address to access the proper memory location. An example of the address translation hardware in an IA-32 processor, such as an Intel® Pentium® processor, is the memory management unit (MMU).

A typical computer, or computing node, or server, in a computer network includes a processor, or central processing unit (CPU), a host memory (or system memory), an I/O bus, and one or more I/O adapters. The I/O adapters, also referred to by other names such as network interface cards (NICs) or storage adapters, include an interface to the network media, such as Ethernet, Fibre Channel, INFINIBAND, etc. The I/O adapters also include an interface to the computer I/O bus (also referred to as a local bus, such as a PCI bus). The I/O adapters transfer data between the host memory and the network media via the I/O bus interface and network media interface.

An RDMA Write operation posted by the system CPU made to an RDMA enabled I/O adapter includes a virtual address and a length identifying locations of the data to be read from the host memory of the local computer and transferred over the network to the remote computer. Conversely, an RDMA Read operation posted by the system CPU to an I/O adapter includes a virtual address and a length identifying locations in the local host memory to which the data received from the remote computer on the network is to be written. The I/O adapter must supply physical addresses on the computer system's I/O bus to access the host memory. Consequently, an RDMA requires the I/O adapter to perform the translation of the virtual address to a physical address to access the host memory. In order to perform the address translation, the operating system address translation information must be supplied to the I/O adapter. The operation of supplying an RDMA enabled I/O adapter with the address translation information for a virtually contiguous memory region is commonly referred to as a memory registration.

Effectively, the RDMA enabled I/O adapter must perform the memory management, and in particular the address translation, that the operating system and CPU perform in order to allow applications to perform RDMA data transfers. One obvious way for the RDMA enabled I/O adapter to perform the memory management is the way the operating system and CPU perform memory management. As an example, many CPUs are Intel IA-32 processors that perform segmentation and paging, as shown in FIGS. 1 and 2, which are essentially reproductions of FIG. 3-1 and FIG. 3-12 of the IA-32 Intel® Architecture Software Developer's Manual, Volume 3: System Programming Guide, Order Number 253668, January 2006, available from Intel Corporation, which may be accessed at http://developer.intel.com/design/pentium4/manuals/index_new.htm.

The processor calculates a virtual address (referred to in FIGS. 1 and 2 as a linear address) in response to a memory access by a program executing on the CPU. The linear address comprises three components—a page directory index portion (Dir or Directory), a page table index portion (Table), and a byte offset (Offset). FIG. 2 assumes a physical memory page size of 4 KB. The page tables and page directories of FIGS. 1 and 2 are the data structures used to describe the mapping of physical memory pages that back a virtual memory region. Each page table has a fixed number of entries. Each page table entry stores the physical page address of a different physical memory page and other memory management information regarding the page, such as access control information. Each page directory also has a fixed number of entries. Each page directory entry stores the base address of a page table.

To translate a virtual, or linear, address to a physical address, the IA-32 MMU performs the following steps. First, the MMU adds the directory index bits of the virtual address to the base address of the page directory to obtain the address of the appropriate page directory entry. (The operating system previously programmed the page directory base address of the currently executing process, or task, into the page directory base register (PDBR) of the MMU when the process was scheduled to become the current running process.) The MMU then reads the page directory entry to obtain the base address of the appropriate page table. The MMU then adds the page table index bits of the virtual address to the page table base address to obtain the address of the appropriate page table entry. The MMU then reads the page table entry to obtain the physical memory page address, i.e., the base address of the appropriate physical memory page, or physical address of the first byte of the memory page. The MMU then adds the byte offset bits of the virtual address to the physical memory page address to obtain the physical address translated from the virtual address.

The IA-32 page tables and page directories are each 4 KB and are aligned on 4 KB boundaries. Thus, each page table and each page directory has 1024 entries, and the IA-32 two-level page directory/page table scheme can specify virtual to physical memory page address translation information for 2ˆ20 memory pages. As may be observed, the amount of memory the operating system must allocate for page tables to perform address translation for even a small memory region (even a single byte) is relatively large. However, this apparent inefficiency is typically not as it appears because most programs require a linear address space that is larger than the amount of memory allocated for page tables. Thus, in the host computer realm, the IA-32 scheme is a reasonable tradeoff in terms of memory usage.

As may also be observed, the IA-32 scheme requires two memory accesses to translate a virtual address to a physical address: a first to read the appropriate page directory entry and a second to read the appropriate page table entry. These two memory accesses may appear to impose undue pressure on the host memory in terms of memory bandwidth and latency, particularly in light of the present disparity between CPU cache memory access times and host memory access times and the fact that CPUs tend to make frequent relatively small load/store accesses to memory. However, the apparent bandwidth and latency pressure imposed by the two memory accesses is largely alleviated by a translation lookaside buffer within the MMU that caches recently used page table entries.

As mentioned above, the memory management function imposed upon host computer virtual memory systems typically has at least two characteristics. First, the memory regions are typically relatively large virtually contiguous regions. This is mainly because most operating systems perform page swapping, or demand paging, and therefore allow a program to use the entire virtual memory space of the processor. Second, the memory regions are typically relatively static; that is, memory regions are typically allocated and de-allocated relatively infrequently. This is mainly because programs tend to run a relatively long time before they exit.

In contrast, the memory management functions imposed upon RDMA enabled I/O adapters are typically quite the opposite of processors with respect to the two characteristics of memory region size and allocation frequency. This is because RDMA application programs tend to allocate buffers to transfer data that are relatively small compared to the size of a typical program. For example, it is not unusual for a memory region to be merely the size of a memory page when used for inter-processor communications (IPC), such as commonly employed in clustering systems. Additionally, unfortunately many application programs tend to allocate and de-allocate a buffer each time they perform an I/O operation, rather than initially allocating buffers and re-using them, which causes the I/O adapter to receive memory region registrations much more frequently than the frequency at which programs are started and terminated. This application program behavior may also require the I/O adapter to maintain many more memory regions during a period of time than the host computer operating system.

Because RDMA enabled I/O adapters are typically requested to register a relatively large number of relatively small memory regions and are requested to do so relatively frequently, it may be observed that employing a two-level page directory/page table scheme such as the IA-32 processor scheme may cause the following inefficiencies. First, a substantial amount of memory may be required on the I/O adapter to store all of the page directories and page tables for the relatively large number of memory regions. This may significantly drive up the cost of an RDMA enabled I/O adapter. An alternative is for the I/O adapter to generate an error in response to a memory registration request due to lack of resources. This is an undesirable solution. Second, as mentioned above, the two-level scheme requires at least two memory accesses per virtual address translation required by an RDMA request—one to read the appropriate page directory entry and one to read the appropriate page table entry. The two memory accesses may add latency to the address translation process and to the processing of an RDMA request. Additionally, the two memory accesses impose additional memory bandwidth consumption pressure upon the I/O adapter memory system.

Finally, it has been noted by the present inventors that in many cases the memory regions registered with an I/O adapter are not only virtually contiguous (by definition), but are also physically contiguous, for at least two reasons. First, because a significant portion of the memory regions tend to be relatively small, they may be smaller than or equal to the size of a physical memory page. Second, a memory region may be allocated to an application or device driver by the operating system at a time when physically contiguous memory pages were available to satisfy the needs of the requested memory region, which may particularly occur if the device driver or application runs soon after the system is bootstrapped and continues to run throughout the uptime of the system. In such a situation in which the memory region is physically contiguous, allocating a full two-level IA-32-style set of page directory/page table resources by the I/O adapter to manage the memory region is a significantly inefficient use of I/O adapter memory.

Therefore, what is needed is an efficient memory registration scheme for RDMA enabled I/O adapters.

### BRIEF SUMMARY OF INVENTION

The present invention provides an I/O adapter that allocates a variable set of data structures in its local memory for storing memory management information to perform virtual to physical address translation depending upon multiple factors. One of the factors is whether the memory pages of the registered memory region are physically contiguous. Another factor is whether the number of non-physically-contiguous memory pages is greater than the number of entries in a page table. Another factor is whether the number of non-physically-contiguous memory pages is greater than the number of entries in a small page table or a large page table. Based on the factors, a zero-level, one-level, or two-level structure for storing the translation information is allocated. Advantageously, the smaller the number of levels, the fewer accesses to the I/O adapter memory need be made in response to an RDMA request for which address translation must be performed. Also advantageously, the amount of I/O adapter memory required to store the translation information may be significantly reduced, particularly for a mix of memory region registrations in which the size and frequency of access is skewed toward the smaller memory regions.

In one aspect, the present invention provides a method for performing memory registration for an I/O adapter having a memory. The method includes creating a first pool of a first type of page table and a second pool of a second type of page table within the I/O adapter memory. The first type of page table includes storage for a first predetermined number of entries each for storing a physical page address. The second type of page table includes storage for a second predetermined number of entries each for storing a physical page address. The second predetermined number of entries is greater than the first predetermined number of entries. The method also includes, in response to receiving a memory registration request specifying physical page addresses of a number of physical memory pages backing a virtually contiguous memory region, allocating one of the first type of page table for storing the physical page addresses, if the number of physical memory pages is less than or equal to the first predetermined number of entries, and allocating one of the second type of page table for storing the physical page addresses, if the number of physical memory pages is greater than the first predetermined number of entries and less than or equal to the second predetermined number of entries.

In another aspect, the present invention provides a method for registering a memory region with an I/O adapter, in which the memory region comprises a virtually contiguous memory range implicating a plurality of physical memory pages in a host computer coupled to the I/O adapter, and the I/O adapter includes a memory. The method includes receiving a memory registration request. The request includes a list specifying a physical page address of each of the plurality of physical memory pages. The method also includes allocating an entry in a memory region table of the I/O adapter memory for the memory region, in response to receiving the memory registration request. The method also includes determining whether the plurality of physical memory pages are physically contiguous based on the list of physical page addresses. The method also includes, if the plurality of physical memory pages are physically contiguous, forgoing allocating any page tables for the memory region, and storing a physical page address of a beginning physical memory page of the plurality of physical memory pages into the memory region table entry.

In another aspect, the present invention provides an I/O adapter for interfacing a host computer to a transport medium, in which the host computer has a memory for storing virtually contiguous memory regions each backed by a plurality of physical memory pages, and the memory regions have been previously registered with the I/O adapter. The I/O adapter includes a memory that stores a memory region table. The table includes a plurality of entries. Each entry stores an address and an indicator associated with one of the virtually contiguous memory regions. The indicator indicates whether the plurality of memory pages backing the memory region are physically contiguous. The I/O adapter also includes a protocol engine, coupled to the memory region table, which receives from the host computer a request to transfer data between the transport medium and a location specified by a virtual address within the memory region associated with one of the plurality of table entries. The virtual address is specified by the data transfer request. The protocol engine reads the table entry associated with the memory region, in response to receiving the request. If the indicator indicates the plurality of memory pages are physically contiguous, the memory region table entry address is a physical page address of one of the plurality of memory pages that includes the location specified by the virtual address.

In another aspect, the present invention provides an I/O adapter for interfacing a host computer to a transport medium, in which the host computer has a memory. The I/O adapter includes a memory region table including a plurality of entries. Each entry stores an address and a level indicator associated with a memory region. The I/O adapter also includes a protocol engine, coupled to the memory region table, which receives from the host computer a request to transfer data between the transport medium and a virtual address in a memory region in the host memory associated with an entry in the memory region table. The protocol engine responsively reads the memory region table entry and examines the entry level indicator. If the level indicator indicates two levels, the protocol engine reads an address of a page table from an entry in a page directory. The entry within the page directory is specified by a first index comprising a first portion of the virtual address. An address of the page directory is specified by the memory region table entry address. The protocol engine further reads a physical page address of a physical memory page backing the virtual address from an entry in the page table. The entry within the page table is specified by a second index comprising a second portion of the virtual address. If the level indicator indicates one level, the protocol engine reads the physical page address of the physical memory page backing the virtual address from an entry in a page table. The address of the page directory is specified by the memory region table entry address. The entry within the page table is specified by the second index comprising the second portion of the virtual address.

In another aspect, the present invention provides an RDMA-enabled I/O adapter for interfacing a host computer to a transport medium, in which the host computer has a host memory. The I/O adapter includes a memory region table including a plurality of entries. Each entry stores information describing a memory region. The I/O adapter also includes a protocol engine, coupled to the memory region table, that receives first, second, and third RDMA requests specifying respective first, second, and third virtual addresses in respective first, second, and third memory regions described in respective first, second, and third of the plurality of memory region table entries. In response to the first RDMA request, the protocol engine reads the first entry to obtain a physical page address specifying a first physical memory page backing the first virtual address. In response to the second RDMA request, the protocol engine reads the second entry to obtain an address of a first page table, and reads an entry in the first page table indexed by a first portion of bits of the virtual address to obtain a physical page address specifying a second physical memory page backing the second virtual address. In response to the third RDMA request, the protocol engine reads the third entry to obtain an address of a page directory, reads an entry in the page directory indexed by a second portion of bits of the virtual address to obtain an address of a second page table, and reads an entry in the second page table indexed by the first portion of bits of the virtual address to obtain a physical page address specifying a third physical memory page backing the third virtual address.

In another aspect, the present invention provides an I/O adapter for interfacing a host computer to a transport medium, in which the host computer has a memory for storing a virtually contiguous memory region backed by a plurality of physical memory pages, and the memory region has been previously registered with the I/O adapter. The I/O adapter includes a memory for storing address translation information for use by the adapter to translate a virtual address to a physical address of a location within the memory region. The address translation information is stored in the memory in response to the previous registration of the memory region. The I/O adapter also includes a protocol engine, coupled to the memory, that performs only one access to the memory to fetch a portion of the address translation information to translate the virtual address to the physical address, if the plurality of physical memory pages are physically contiguous.

In another aspect, the present invention provides an I/O adapter for interfacing a host computer to a transport medium, in which the host computer has a memory for storing a virtually contiguous memory region backed by a plurality of physical memory pages, and the memory region has been previously registered with the I/O adapter. The I/O adapter includes a memory, for storing address translation information for use by the adapter to translate a virtual address to a physical address of a location within the memory region. The address translation information is stored in the memory in response to the previous registration of the memory region. The I/O adapter also includes a protocol engine, coupled to the memory, that performs only two accesses to the memory to fetch a portion of the address translation information to translate the virtual address to the physical address, if the plurality of physical memory pages are not greater than a predetermined number. The protocol engine performs only three accesses to the memory to fetch a portion of the address translation information to translate the virtual address to the physical address, if the plurality of physical memory pages are greater than the predetermined number.

In another aspect, the present invention provides a method for performing memory registration for an I/O adapter coupled to a host computer, the host computer having a host memory. The method includes creating a first pool of a first type of page table and a second pool of a second type of page table within the host memory. The first type of page table includes storage for a first predetermined number of entries each for storing a physical page address. The second type of page table includes storage for a second predetermined number of entries each for storing a physical page address. The second predetermined number of entries is greater than the first predetermined number of entries. The method also includes, in response to receiving a memory registration request specifying physical page addresses of a number of physical memory pages backing a virtually contiguous memory region, allocating one of the first type of page table for storing the physical page addresses, if the number of physical memory pages is less than or equal to the first predetermined number of entries, and allocating one of the second type of page table for storing the physical page addresses, if the number of physical memory pages is greater than the first predetermined number of entries and less than or equal to the second predetermined number of entries.

In another aspect, the present invention provides a method for registering a virtually contiguous memory region with an I/O adapter, the memory region comprising a virtually contiguous memory range implicating a plurality of physical memory pages in a host computer coupled to the I/O adapter, the host computer having a memory comprising the physical memory pages. The method includes receiving a memory registration request. The request includes a list specifying a physical page address of each of the plurality of physical memory pages. The method also includes allocating an entry in a memory region table of the host computer memory for the memory region, in response to receiving the memory registration request. The method also includes determining whether the plurality of physical memory pages are physically contiguous based on the list of physical page addresses. The method also includes forgoing allocating any page tables for the memory region and storing a physical page address of a beginning physical memory page of the plurality of physical memory pages into the memory region table entry, if the plurality of physical memory pages are physically contiguous.

In another aspect, the present invention provides an I/O adapter for interfacing a host computer to a transport medium, the host computer having a memory. The I/O adapter includes a protocol engine that accesses a memory region table stored in the host computer memory. The table includes a plurality of entries, each storing an address and a level indicator associated with a virtually contiguous memory region. The protocol engine receives from the host computer a request to transfer data between the transport medium and a virtual address in a memory region in the host memory associated with an entry in the memory region table, responsively reads the memory region table entry, and examines the entry level indicator. If the level indicator indicates two levels, the protocol engine reads an address of a page table from an entry in a page directory. The entry within the page directory is specified by a first index comprising a first portion of the virtual address. An address of the page directory is specified by the memory region table entry address. The page directory and the page table are stored in the host computer memory. If the level indicator indicates two levels, the protocol engine also reads a physical page address of a physical memory page backing the virtual address from an entry in the page table. The entry within the page table is specified by a second index comprising a second portion of the virtual address. However, if the level indicator indicates one level, the protocol engine reads the physical page address of the physical memory page backing the virtual address from an entry in a page table. The entry within the page table is specified by the second index comprising the second portion of the virtual address. The address of the page table is specified by the memory region table entry address. The page table is stored in the host computer memory.

### BRIEF DESCRIPTION OF THE DRAWINGS

FIGS. 1 and 2 are block diagrams illustrating memory address translation according to the prior art IA-32 scheme.

FIG. 3 is a block diagram illustrating a computer system according to the present invention.

FIG. 4 is a block diagram illustrating the I/O controller of FIG. 3 in more detail according to the present invention.

FIG. 5 is a flowchart illustrating operation of the I/O adapter according to the present invention.

FIG. 6 is a block diagram illustrating an MRTE of FIG. 3 in more detail according to the present invention.

FIG. 7 is a flowchart illustrating operation of the device driver and I/O adapter of FIG. 3 to perform a memory registration request according to the present invention.

FIG. 8 is four block diagrams illustrating operation of the device driver and I/O adapter of FIG. 3 to perform a memory registration request according to the present invention.

FIG. 9 is a flowchart illustrating operation of the I/O adapter in response to an RDMA request according to the present invention.

FIG. 10 is four block diagrams illustrating operation of the I/O adapter in response to an RDMA request according to the present invention.

FIG. 11 is a table comparing, by way of example, the amount of memory allocation and memory accesses that would be required by the I/O adapter employing the memory management method described herein according to the present invention with an I/O adapter employing a conventional IA-32 memory management method.

FIG. 12 is a block diagram illustrating a computer system according to an alternate embodiment of the present invention.

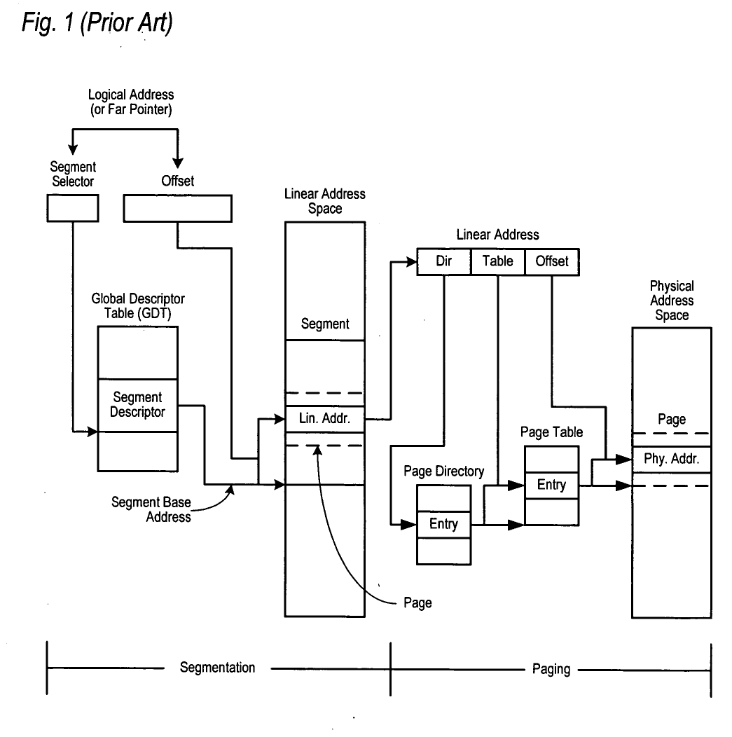

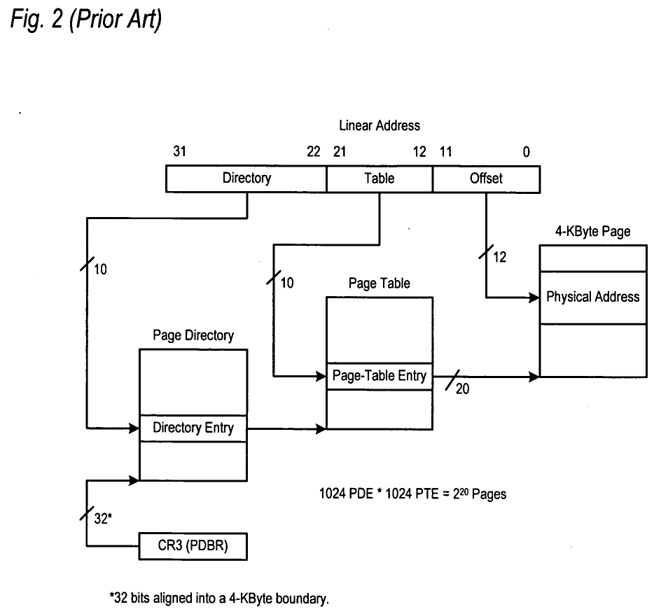

### DETAILED DESCRIPTION

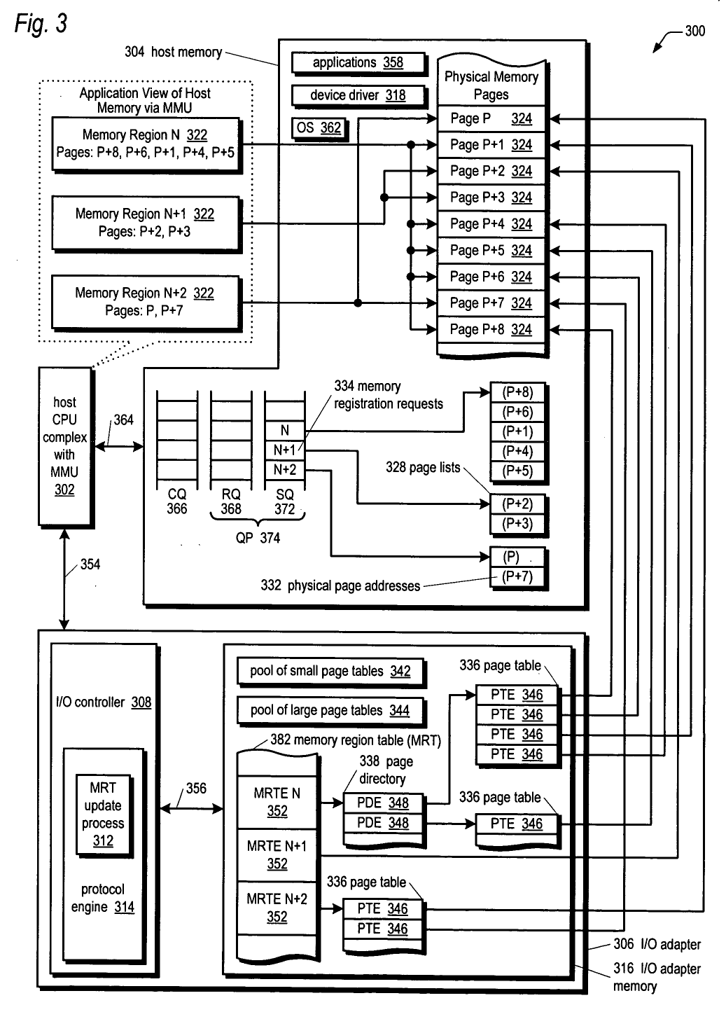

Referring now to FIG. 3, a block diagram illustrating a computer system 300 according to the present invention is shown. The system 300 includes a host computer CPU complex 302 coupled to a host memory 304 via a memory bus 364, and an RDMA enabled I/O adapter 306 via a local bus 354, such as a PCI bus. The CPU complex 302 includes a CPU, or processor, including but not limited to, an IA-32 architecture processor, which fetches and executes program instructions and data stored in the host memory 304. The CPU complex 302 executes an operating system 362, a device driver 318 to control the I/O adapter 306, and application programs 358 that also directly request the I/O adapter 306 to perform RDMA operations. The CPU complex 302 includes a memory management unit (MMU) for managing the host memory 304, including enforcing memory access protection and performing virtual to physical address translation. The CPU complex 302 also includes a memory controller for controlling the host memory 304. The CPU complex 302 also includes one or more bridge circuits for bridging the processor bus and host memory bus 364 to the local bus 354 and other I/O buses. The bridge circuits may include what are commonly referred to as a North Bridge or Memory Control Hub (MCH) and a South Bridge or I/O Control Hub (ICH), which includes I/O bus interfaces, such as an interface to an ISA bus or a PCI-family bus.

The operating system 362 manages the host memory 304 as a set of physical memory pages 324 that back the virtual memory address space presented to application programs 358 by the operating system 362. FIG. 3 shows nine specific physical memory pages 324, denoted P, P+1, P+2, and so forth through P+8. The physical memory pages 324 P through P+8 are physically contiguous. In the example of FIG. 3, the nine physical memory pages 324 have been allocated for use as three different memory regions 322, denoted N, N+1, and N+2. Physical memory pages 324 P+8, P+6, P+1, P+4, and P+5 have been allocated to memory region 322 N; physical memory pages 324 P+2 and P+3 (which are physically contiguous) have been allocated to memory region 322 N+1 ; and physical memory pages 324 P and P+7 have been allocated to memory region 322 N+2. The CPU complex 302 MMU presents a virtually contiguous view of the memory regions 322 to the application programs 358 although they are physically discontiguous.

The host memory 304 also includes a queue pair (QP) 374, which includes a send queue (SQ) 372 and a receive queue (RQ) 368. The QP 374 enables the application programs 358 and device driver 318 to submit work queue elements (WQEs) to the I/O adapter 306 and receive WQEs from the I/O adapter 306. The host memory 304 also includes a completion queue (CQ) 366 that enables the application programs 358 and device driver 318 to receive completion queue entries (CQEs) of completed WQEs. The QP 374 and CQ 366 may comprise, but are not limited to, implementations as specified by the iWARP or INFINIBAND specifications. In one embodiment, the I/O adapter 306 comprises a plurality of QPs similar to QP 374. The QPs 374 include a control QP, which is mapped into kernel address space and used by the operating system 362 and device driver 318 to post memory registration requests 334 and other administrative requests. The QPs 374 also comprise a dedicated QP 374 for each RDMA-enabled network connection (such as a TCP connection) to submit RDMA requests to the I/O adapter 306. The connection-oriented QPs 374 are typically mapped into user address space so that user-level application programs 358 can post requests to the I/O adapter 306 without transitioning to kernel level.

The application programs 358 and device driver 318 may submit RDMA requests and memory registration requests 334 to the I/O adapter 306 via the SQs 372. The memory registration requests 334 provide the I/O adapter 306 with a means for the I/O adapter 306 to map virtual addresses to physical addresses of a memory region 322. The memory registration requests 334 may include, but are not limited to, an iWARP Register Non-Shared Memory Region Verb or an INFINIBAND Register Memory Region Verb. FIG. 3 illustrates as an example three memory registration requests 334 (denoted N, N+1, and N+2) in the SQ 372 for registering with the I/O adapter 306 the three memory regions 322 N, N+1, and N+2, respectively. Each of the memory registration requests 334 specifies a page list 328. Each page list 328 includes a list of physical page addresses 332 of the physical memory pages 324 included in the memory region 322 specified by the memory registration request 334. Thus, as shown in FIG. 3, memory registration request 334 N specifies the physical page addresses 332 of physical memory pages 324 P+8, P+6, P+1, P+4, and P+5 ; memory registration request 334 N+1 specifies the physical page addresses 332 of physical memory pages 324 P+2 and P+3 ; memory registration request 334 N+2 specifies the physical page addresses 332 of physical memory pages 324 P and P+7. The memory registration requests 334 also include information specifying the size of the physical memory pages 324 in the page list 328 and the length of the memory region 322. The memory registration requests 334 also include an indication of whether the virtual addresses used by RDMA requests to access the memory region 322 will be offsets from the beginning of the virtual memory region 322 or will be full virtual addresses. If full virtual addresses will be used, the memory registration requests 334 also provide the full virtual address of the first byte of the memory region 322. The memory registration requests 334 may also include a first byte offset (FBO) of the first byte of the memory region 322 within the first, or beginning, physical memory page 324. The memory registration requests 334 also include information specifying the length of the page list 328 and access control privileges to the memory region 322. The memory registration requests 334 and page lists 328 may comprise, but are not limited to, implementations as specified by iWARP or INFINIBAND specifications. In response to the memory registration request 334, the I/O adapter 306 returns an identifier, or index, of the registered memory region 322, such as an iWARP Steering Tag (STag) or INFINIBAND memory region handle.

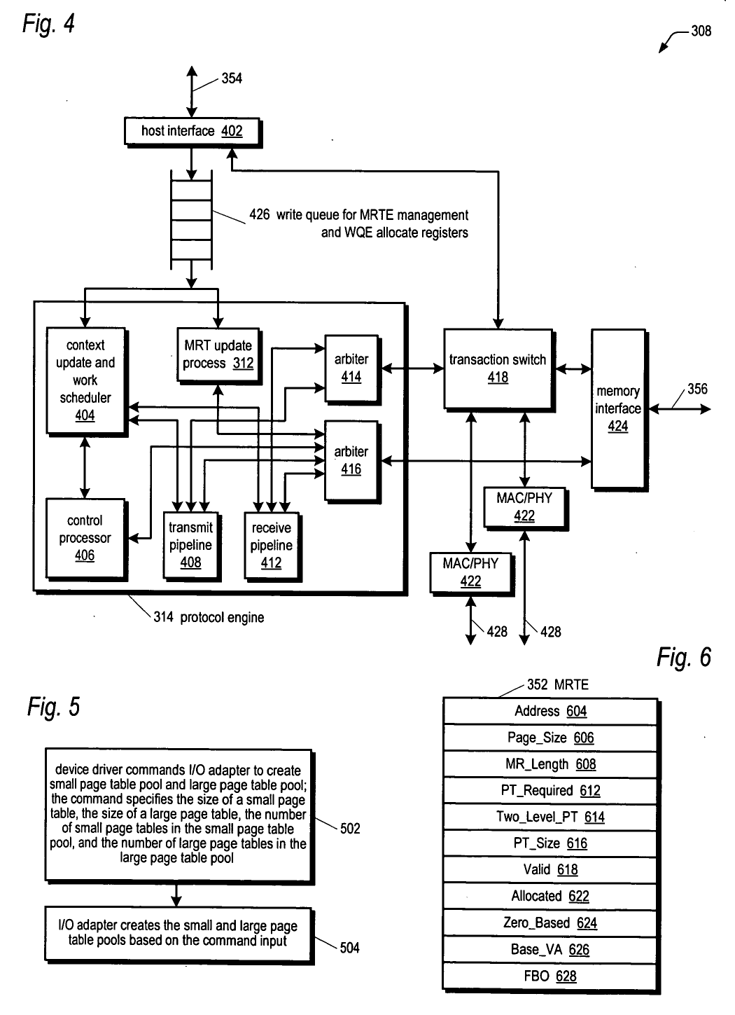

The I/O adapter 306 includes an I/O controller 308 coupled to an I/O adapter memory 316 via a memory bus 356. The I/O controller 308 includes a protocol engine 314, which executes a memory region table (MRT) update process 312. The I/O controller 308 transfers data with the I/O adapter memory 316, with the host memory 304, and with a network via a physical data transport medium 428 (shown in FIG. 4). In one embodiment, the I/O controller 308 comprises a single integrated circuit. The I/O controller 308 is described in more detail with respect to FIG. 4.

The I/O adapter memory 316 stores a variety of data structures, including a memory region table (MRT) 382. The MRT 382 comprises an array of memory region table entries (MRTE) 352. The contents of an MRTE 352 are described in detail with respect to FIG. 6. In one embodiment, an MRTE 352 comprises 32 bytes. The MRT 382 is indexed by a memory region identifier, such as an iWARP STag or INFINIBAND memory region handle. The I/O adapter memory 316 also stores a plurality of page tables 336. The page tables 336 each comprise an array of page table entries (PTE) 346. Each PTE 346 stores a physical page address 332 of a physical memory page 324 in host memory 304. Some of the page tables 336 are employed as page directories 338. The page directories 338 each comprise an array of page directory entries (PDE) 348. Each PDE 348 stores a base address of a page table 336 in the I/O adapter memory 316. That is, a page directory 338 is simply a page table 336 used as a page directory 338 (i.e., to point to page tables 336) rather than as a page table 336 (i.e., to point to physical memory pages 324).

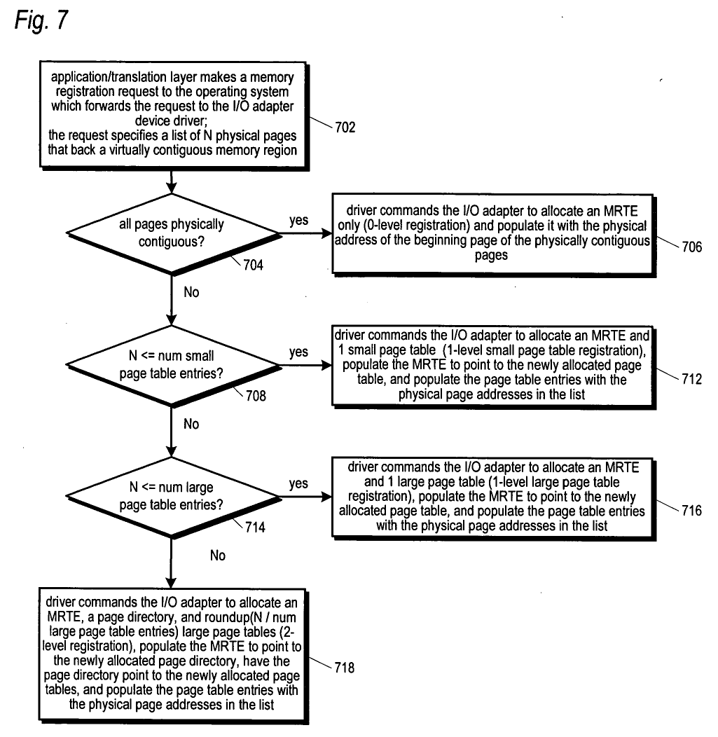

Advantageously, the I/O adapter 306 is capable of employing page tables 336 of two different sizes, referred to herein as small page tables 336 and large page tables 336, to enable more efficient use of the I/O adapter memory 316, as described herein. In one embodiment, the size of a PTE 346 is 8 bytes. In one embodiment, the small page tables 336 each comprise 32 PTEs 346 (or 256 bytes) and the large page tables 336 each comprise 512 PTEs 346 (or 4 KB). The I/O adapter memory 316 stores a free pool of small page tables 342 and a free pool of large page tables 344 that are allocated for use in managing a memory region 322 in response to a memory registration request 334, as described in detail with respect to FIG. 7. The page tables 336 are freed back to the pools 342/344 in response to a memory region 322 de-registration request so that they may be re-used in response to subsequent memory registration requests 334. In one embodiment, the protocol engine 314 of FIG. 3 creates the page table pools 342/344 and controls the allocation of page tables 336 from the pools 342/344 and the deallocation, or freeing, of the page tables 336 back to the pools 342/344.

FIG. 3 illustrates allocated page tables 336 for memory registrations of the example three memory regions 322 N, N+1, and N+2. In the example of FIG. 3, for the purpose of illustrating the present invention, the page tables 336 each include only four PTEs 346, although as discussed above other embodiments include larger numbers of PTEs 346. In FIG. 3, MRTE 352 N points to a page directory 338. The first PDE 348 of the page directory 338 points to a first page table 336 and the second PDE 348 of the page directory 338 points to a second page table 336. The first PTE 346 of the first page table 336 stores the physical page address 332 of physical memory page 324 P+8 ; the second PTE 346 stores the physical page address 332 of physical memory page 324 P+6 ; the third PTE 346 stores the physical page address 332 of physical memory page 324 P+1 ; the fourth PTE 346 stores the physical page address 332 of physical memory page 324 P+4. The first PTE 346 of the second page table 336 stores the physical page address 332 of physical memory page 324 P+5.

MRTE 352 N+1 points directly to physical memory page 324 P+2, i.e., MRTE 352 N stores the physical page address 332 of physical memory page 324 P+2. This is possible because the physical memory pages 324 for memory region 322 N+1 are all contiguous, i.e., physical memory page 324 P+2 and P+3 are physically contiguous. Advantageously, a minimal amount of I/O adapter memory 316 is used to store the information for managing memory region 322 N+1 because it is detected that all the physical memory pages 324 are physically contiguous, as described in more detail with respect to the remaining Figures. That is, rather than unnecessarily allocating two levels of page table 336 resources, the I/O adapter 306 allocates zero page tables 336.

MRTE 352 N+2 points to a third page table 336. The first PTE 346 of the third page table 336 stores the physical page address 332 of physical memory page 324 P, and the second PTE 346 stores the physical page address 332 of physical memory page 324 P+7. Advantageously, a smaller amount of I/O adapter memory 316 is used to store the information for managing memory region 322 N+2 than for memory region 322 N because the I/O adapter 306 detects that the number of physical memory pages 324 may be specified by a single page table 336 and does not require two levels of page table 336 resources, as described in more detail with respect to the remaining Figures.

Referring now to FIG. 4, a block diagram illustrating the I/O controller 308 of FIG. 3 in more detail according to the present invention is shown. The I/O controller 308 includes a host interface 402 that couples the I/O adapter 306 to the host CPU complex 302 via the local bus 354 of FIG. 3. The host interface 402 is coupled to a write queue 426. Among other things, the write queue 426 receives notification of new work requests from the application programs 358 and device driver 318. The notifications inform the I/O adapter 306 that the new work request has been enqueued on a QP 374, which may include memory registration requests 334 and RDMA requests.

The I/O controller 308 also includes the protocol engine 314 of FIG. 3, which is coupled to the write queue 426; a transaction switch 418, which is coupled to the host interface 402 and protocol engine 314; a memory interface 424, which is coupled to the transaction switch 418, protocol engine 314, and I/O adapter memory 316 memory bus 356; and two media access controller (MAC)/physical interface (PHY) circuits 422, which are each coupled to the transaction switch 418 and physical data transport medium 428. The physical data transport medium 428 interfaces the I/O adapter 306 to the network. The physical data transport medium 428 may include, but is not limited to, Ethernet, Fibre Channel, INFINIBAND, SCSI, HIPPI, Token Ring, Arcnet, FDDI, LocalTalk, ESCON, FICON, ATM, SAS, SATA, iSCSI, and the like. The memory interface 424 interfaces the I/O adapter 306 to the I/O adapter memory 316. The transaction switch 418 comprises a high speed switch that switches and translates transactions, such as PCI transactions, transactions of the physical data transport medium 428, and transactions with the protocol engine 314 and host interface 402. In one embodiment, U.S. Pat. No. 6,594,712 describes substantial portions of the transaction switch 418.

The protocol engine 314 includes a control processor 406, a transmit pipeline 408, a receive pipeline 412, a context update and work scheduler 404, an MRT update process 312, and two arbiters 414 and 416. The context update and work scheduler 404 and MRT update process 312 receive notification of new work requests from the write queue 426. In one embodiment, the context update and work scheduler 404 comprises a hardware state machine, and the MRT update process 312 comprises firmware instructions executed by the control processor 406. However, it should be noted that the functions described herein may be performed by hardware, firmware, software, or various combinations thereof. The context update and work scheduler 404 communicates with the receive pipeline 412 and the transmit pipeline 408 to process RDMA requests. The MRT update process 312 reads and writes the I/O adapter memory 316 to update the MRT 382 and allocate and de-allocate MRTEs 352, page tables 336, and page directories 338 in response to memory registration requests 334. The output of the first arbiter 414 is coupled to the transaction switch 418, and the output of the second arbiter 416 is coupled to the memory interface 424. The requesters of the first arbiter 414 are the receive pipeline 412 and the transmit pipeline 408. The requesters of the second arbiter 416 are the receive pipeline 412, the transmit pipeline 408, the control processor 406, and the MRT update process 312. The protocol engine 314 also includes a direct memory access controller (DMAC) for transferring data between the transaction switch 418 and the host memory 304 via the host interface 402.

Referring now to FIG. 5, a flowchart illustrating operation of the I/O adapter 306 according to the present invention is shown. The flowchart of FIG. 5 illustrates steps performed during initialization of the I/O adapter 306. Flow begins at block 502. [0056] At block 502, the device driver 318 commands the I/O adapter 306 to create the pool of small page tables 342 and pool of large page tables 344. The command specifies the size of a small page table 336 and the size of a large page table 336. In one embodiment, the size of a page table 336 must be a power of two. The command also specifies the number of small page tables 336 to be included in the pool of small page tables 342 and the number of large page tables 336 to be included in the pool of large page tables 344. Advantageously, the device driver 318 may configure the page table 336 resources of the I/O adapter 306 to optimally employ its I/O adapter memory 316 to match the type of memory regions 322 that will be registered with the I/O adapter 306. Flow proceeds to block 504.

At block 504, the I/O adapter 306 creates the pool of small page tables 342 and the pool of large page tables 344 based on the information specified in the command received at block 502. Flow ends at block 504.

Referring now to FIG. 6, a block diagram illustrating an MRTE 352 of FIG. 3 in more detail according to the present invention is shown. The MRTE 352 includes an Address field 604. The MRTE 352 also includes a PT_Required bit 612. If the PT_Required bit 612 is set, then the Address 604 points to a page table 336 or page directory 338; otherwise, the Address 604 value is the physical page address 332 of a physical memory page 324 in host memory 304, as described with respect to FIG. 7. The MRTE 352 also includes a Page_Size field 606 that indicates the size of a page in the host computer memory of the physical memory pages 324 backing the virtual memory region 322. The memory registration request 334 specifies the page size for the memory region 322. The MRTE 352 also includes an MR_Length field 608 that specifies the length of the memory region 322 in bytes. The memory registration request 334 specifies the length of the memory region 322.

The MRTE 352 also includes a Two_Level_PT bit 614. When the PT-Required bit 612 is set, then if the Two_Level_PT bit 614 is set, the Address 604 points to a page directory 338; otherwise, the Address 604 points to a page table 336. The MRTE 352 also includes a PT_Size 616 field that indicates whether small or large page tables 336 are being used to store the page translation information for this memory region 322.

The MRTE 352 also includes a Valid bit 618 that indicates whether the MRTE 352 is associated with a valid memory region 322 registration. The MRTE 352 also includes an Allocated bit 622 that indicates whether the index into the MRT 382 for the MRTE 352 (e.g., iWARP STag or INFINIBAND memory region handle) has been allocated. For example, an application program 358 or device driver 318 may request the I/O adapter 306 to perform an Allocate Non-Shared Memory Region STag Verb to allocate an STag, in response to which the I/O adapter 306 will set the Allocated bit 622 for the allocated MRTE 352; however, the Valid bit 618 of the MRTE 352 will remain clear until the I/O adapter 306 receives, for example, a Register Non-Shared Memory Region Verb specifying the STag, at which time the Valid bit 618 will be set.

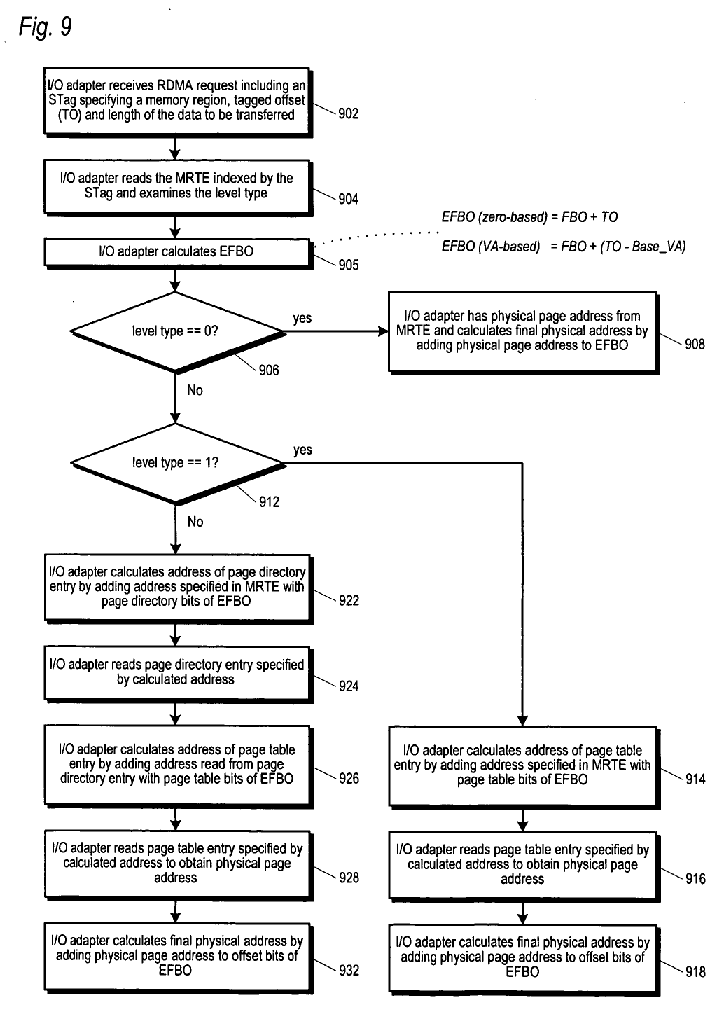

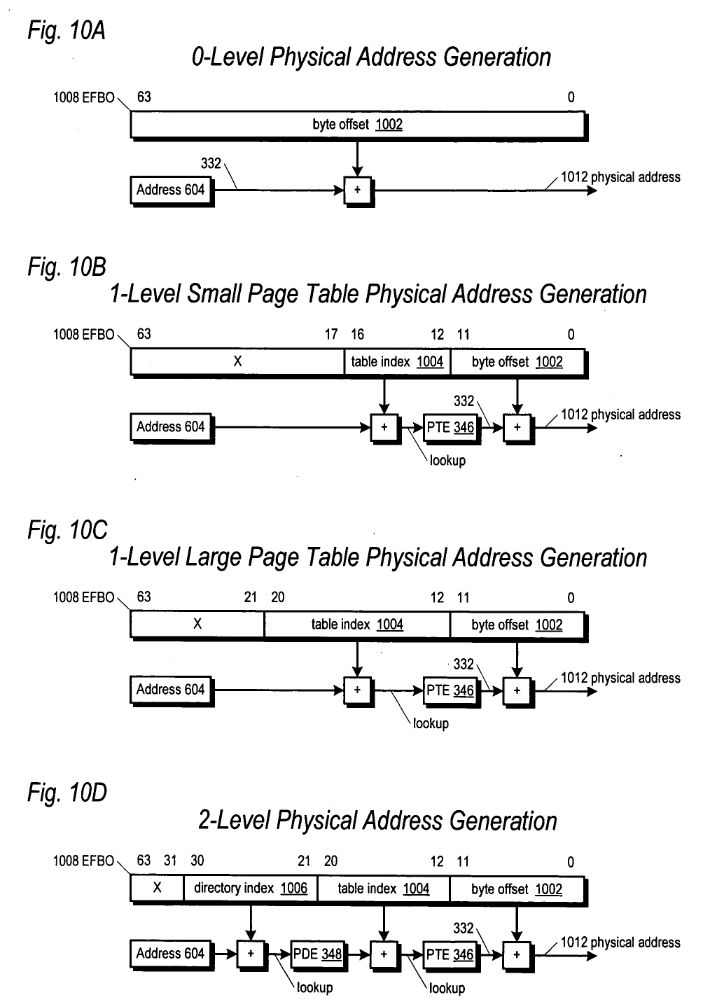

The MRTE 352 also includes a Zero_Based bit 624 that indicates whether the virtual addresses used by RDMA operations to access the memory region 322 will be offsets from the beginning of the virtual memory region 322 or will be full virtual addresses. For example, the iWARP specification refers to these two modes as virtual address-based tagged offset (TO) memory-regions and zero-based TO memory regions. A TO is the iWARP term used for the value supplied in an RDMA request that specifies the virtual address of the first byte to be transferred. Thus, the TO may be either a full virtual address or a zero-based offset virtual address, depending upon the memory region 322 mode. The TO in combination with the STag memory region identifier enables the I/O adapter 306 to generate a physical address of data to be transferred by an RDMA operation, as described with respect to FIGS. 9 and 10. The MRTE 352 also includes a Base_VA field 626 that stores the virtual address of the first byte of data of the memory region 322 if the memory region 322 is a virtual address-based TO memory region 322 (i.e., if the Zero_Based bit 624 is clear). Thus, for example, if the application program 358 accesses the buffer at virtual address 0x12345678, then the I/O adapter 306 will populate the Base_VA field 626 with a value of 0x12345678. The MRTE 352 also includes an FBO field 628 that stores the offset of the first byte of data of the memory region 322 in the first physical memory page 324 specified in the page list 328. Thus, for example, if the application program 358 buffer begins at byte offset 7 of the first physical memory page 324 of the memory region 322, then the I/O adapter 306 will populate the FBO field 628 with a value of 7. An iWARP memory registration request 334 explicitly specifies the FBO.

Referring now to FIG. 7, a flowchart illustrating operation of the device driver 318 and I/O adapter 306 of FIG. 3 to perform a memory registration request 334 according to the present invention is shown. Flow begins at block 702.

At block 702, an application program 358 makes a memory registration request 334 to the operating system 362, which validates the request 334 and then forwards it to the device driver 318 all of FIG. 3. As described above with respect to FIG. 3, the memory registration request 334 includes a page list 328 that specifies the physical page addresses 332 of a number of physical memory pages 324 that back a virtually contiguous memory region 322. In one embodiment, a translation layer of software executing on the host CPU complex 302 makes the memory registration request 334 rather than an application program 358. The translation layer may be necessary for environments that do not export the memory registration capabilities to the application program 358 level. For example, Microsoft Winsock Direct allows unmodified sockets applications to run over RDMA enabled I/O adapters 306. A sockets-to-verbs translation layer performs the function of pinning physical memory pages 324 allocated by the application program 358 so that the pages 324 are not swapped out to disk, and registering the pinned physical memory pages 324 with the I/O adapter 306 in a manner that is hidden from the application program 358. It is noted that in such a configuration, the application program 358 may not be aware of the costs associated with memory registration, and consequently may use a different buffer for each I/O operation, thereby potentially causing the phenomenon described above in which small memory regions 322 are allocated on a frequent basis, relative to the size and frequency of the memory management performed by the operating system 362 and handled by the host CPU complex 302. Additionally, the translation layer may implement a cache of buffers formed by leaving one or more memory regions 322 pinned and registered with the I/O adapter 306 after the first use by an application program 358 (such as in a socket write), on the assumption that the buffers are likely to be reused on future I/O operations by the application program 358. Flow proceeds to decision block 704.

At decision block 704, the device driver 318 determines whether all of the physical memory pages 324 specified in the page list 328 of the memory registration request 334 are physically contiguous, such as memory region 322 N+1 of FIG. 3. If so, flow proceeds to block 706; otherwise, flow proceeds to decision block 708.

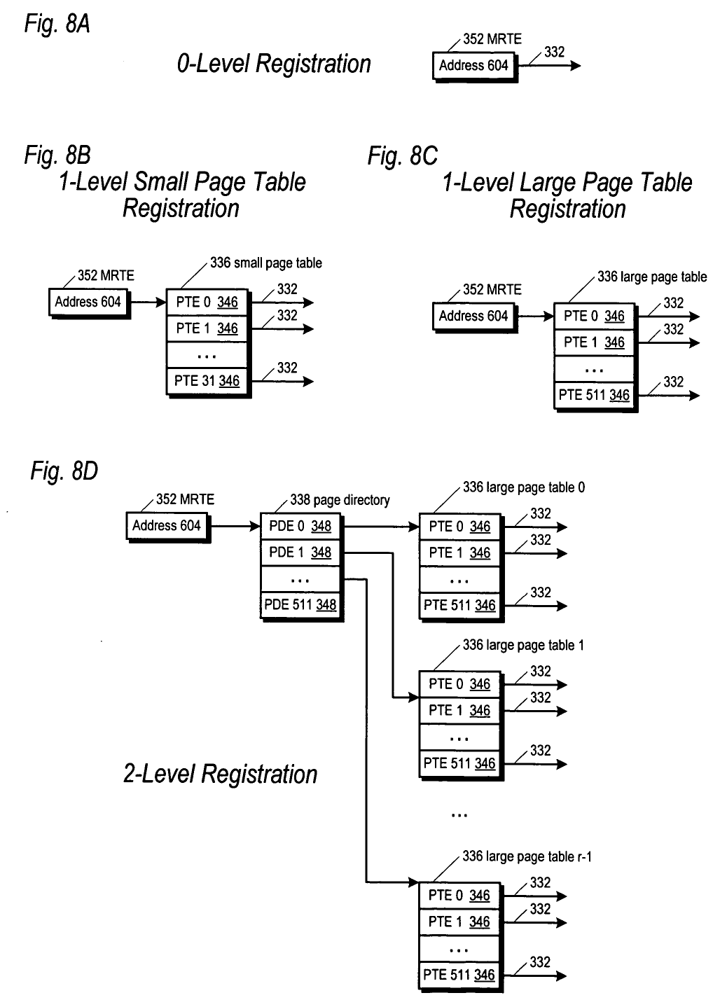

At block 706, the device driver 318 commands the I/O adapter 306 to allocate an MRTE 352 only, as shown in FIG. 8A. That is, the device driver 318 advantageously performs a zero-level registration according to the present invention. The device driver 318 also commands the I/O adapter 306 to populate the MRTE 352 Address 604 with the physical page address 332 of the beginning physical memory page 324 of the physically contiguous physical memory pages 324 and to clear the PT_Required bit 612. In the example of FIG. 3, the I/O adapter 306 has populated the Address 604 of MRTE 352 N+1 with the physical page address 332 of physical memory page 324 P+2 since it is the beginning physical memory page 324 in the set of physically contiguous physical memory pages 324, i.e., the physical memory page 324 having the lowest physical page address 332. Advantageously, the maximum size of the memory region 322 for which a zero-level memory registration may be performed is limited only by the number of physically contiguous physical memory pages 324, and no additional amount of I/O adapter memory 316 is required for page tables 336. Additionally, the device driver 318 commands the I/O adapter 306 to populate the Page_Size 606, MR_Length 608, Zero_Based 624, and Base_VA 626 fields of the allocated MRTE 352 based on the memory registration request 334 values, as is also performed at blocks 712, 716, and 718. Flow ends at block 706.

At decision block 708, the device driver 318 determines whether the number of physical memory pages 324 specified in the page list 328 is less than or equal to the number of PTEs 346 in a small page table 336. If so, flow proceeds to block 712; otherwise, flow proceeds to decision block 714.

At block 712, the device driver 318 commands the I/O adapter 306 to allocate an MRTE 352 and one small page table 336, as shown in FIG. 8B. That is, the device driver 318 advantageously performs a one-level small page table 336 registration according to the present invention. The device driver 318 also commands the I/O adapter 306 to populate the MRTE 352 Address 604 with the address of the allocated small page table 336, to clear the Two_Level_PT bit 614, populate the PT_Size bit 616 to indicate a small page table 336, and to set the PT_Required bit 612. The device driver 318 also commands the I/O adapter 306 to populate the PTEs 346 of the allocated small page table 336 with the physical page addresses 332 of the physical memory pages 324 in the page list 328. In the example of FIG. 3, the I/O adapter 306 has populated the Address 604 of MRTE 352 N+2 with the address of the page table 336, and the first PTE 346 with the physical page address 332 of physical memory page 324 P, and the second PTE 346 with the physical page address 332 of physical memory page 324 P+7. As an illustration, in the embodiment in which the number of PTEs 346 in a small page table 336 is 32, and assuming a physical memory page 324 size of 4 KB, the maximum size of the memory region 322 for which a one-level small page table 336 memory registration may be performed is 128KB, and the additional amount of I/O adapter memory 316 consumed for page tables 336 is 256 bytes. Flow ends at block 712.

At decision block 714, the device driver 318 determines whether the number of physical memory pages 324 specified in the page list 328 is less than or equal to the number of PTEs 346 in a large page table 336. If so, flow proceeds to block 716; otherwise, flow proceeds to block 718.

At block 716, the device driver 318 commands the I/O adapter 306 to allocate an MRTE 352 and one large page table 336, as shown in FIG. 8C. That is, the device driver 318 advantageously performs a one-level large page table 336 registration according to the present invention. The device driver 318 also commands the I/O adapter 306 to populate the MRTE 352 Address 604 with the address of the allocated large page table 336, to clear the Two_Level_PT bit 614, populate the PT_Size bit 616 to indicate a large page table 336, and to set the PT_Required bit 612. The device driver 318 also commands the I/O adapter 306 to populate the PTEs 346 of the allocated large page table 336 with the physical page addresses 332 of the physical memory pages 324 in the page list 328. As an illustration, in the embodiment in which the number of PTEs 346 in a large page table 336 is 512, and assuming a physical memory page 324 size of 4 KB, the maximum size of the memory region 322 for which a one-level large page table 336 memory registration may be performed is 2 MB, and the additional amount of I/O adapter memory 316 consumed for page tables 336 is 4 KB. Flow ends at block 716.

At block 718, the device driver 318 commands the I/O adapter 306 to allocate an MRTE 352, a page directory 338, and r large page tables 336, where r is equal to the number of physical memory pages 324 in the page list 328 divided by the number of PTEs 346 in a large page table 336 and then rounded up to the nearest integer, as shown in FIG. 8D. That is, the device driver 318 advantageously performs a two-level registration according to the present invention only when required by a page list 328 with a relatively large number of non-contiguous physical memory pages 324. The device driver 318 also commands the I/O adapter 306 to populate the MRTE 352 Address 604 with the address of the allocated page directory 338, to set the Two_Level_PT bit 614, and to set the PT-Required bit 612. The device driver 318 also commands the I/O adapter 306 to populate the first r PDEs 348 of the allocated page directory 338 with the addresses of the r allocated page tables 336. The device driver 318 also commands the I/O adapter 306 to populate the PTEs 346 of the r allocated large page tables 336 with the physical page addresses 332 of the physical memory pages 324 in the page list 328. In the example of FIG. 3, since the number of pages in the page list 328 is five and the number of PTEs 346 in a page table 336 is four, then r is roundup(5/4), which is two; and, the I/O adapter 306 has populated the Address 604 of MRTE 352 N with the address of the page directory 338, the first PDE 348 with the address of the first page table 336, the second PDE 348 with the address of the second page table 336, the first PTE 346 of the first page table 336 with the physical page address 332 of physical memory page 324 P+8, the second PTE 346 of the first page table 336 with the physical page address 332 of physical memory page 324 P+6, the third PTE 346 of the first page table 336 with the physical page address 332 of physical memory page 324 P+1, the fourth PTE 346 of the first page table 336 with the physical page address 332 of physical memory page 324 P+4, and the first PTE 346 of the second page table 336 with the physical page address 332 of physical memory page 324 P+5. As an illustration, in the embodiment in which the number of PTEs 346 in a large page table 336 is 512, and assuming a physical memory page 324 size of 4 KB, the maximum size of the memory region 322 for which a two-level memory registration may be performed is 1GB, and the additional amount of I/O adapter memory 316 consumed for page tables 336 is (r+1)*4 KB. In an alternate embodiment, the device driver 318 allocates a small page table 336 for use as the page directory 338. Flow ends at block 718.

In one embodiment, the device driver 318 may perform an alternate set of steps based on the availability of free small page tables 336 and large page tables 336. For example, if a single large page table 336 is implicated by a memory registration request 334, but no large page tables 336 are available, the device driver 318 may specify a two-level multiple small page table 336 allocation instead. Similarly, if a small page table 336 is implicated by a memory registration request 334, but no small page tables 336 are available, the device driver 318 may specify a single large page table 336 allocation instead.

In one embodiment, if the device driver 318 receives an iWARP Allocate Non-Shared Memory Region STag Verb or an INFINIBAND Allocate L_Key Verb, the device driver 318 performs the steps of FIG. 7 with the following exceptions. First, because the page list 328 is not provided by these Verbs, at blocks 712, 716, and 718 the device driver 318 does not populate the allocated page tables 336 with physical page addresses 332. Second, the device driver 318 does not perform step 704 to determine whether all of the physical memory pages 324 are physically contiguous, since they are not provided. That is, the device driver 318 always allocates the implicated one-level or two-level structure required. However, when a subsequent memory registration request 334 is received with the previously returned STag or L_Key, the device driver 318 will at that time perform the check at block 704 to determine whether all of the physical memory pages 324 are physically contiguous. If so, the device driver 318 may command the I/O adapter 306 to update the MRTE 352 to directly store the physical page address 332 of the beginning physical memory page 324 so that the I/O adapter 306 can perform zero-level accesses in response to subsequent RDMA requests in the memory region 322. Thus, although this embodiment does not reduce the amount of I/O adapter memory 316 used, it may reduce the latency and I/O adapter memory 316 bandwidth utilization by reducing the number of required I/O adapter memory 316 accesses made by the I/O controller 308 to perform the memory address translation.

Referring now to FIG. 9, a flowchart illustrating operation of the I/O adapter 306 in response to an RDMA request according to the present invention is shown. It is noted that the iWARP term tagged offset (TO) is used in the description of an RDMA operation with respect to FIG. 9; however, the steps described in FIG. 9 may be employed by an RDMA enabled I/O adapter 306 to perform RDMA operations specified by other protocols, including but not limited to INFINIBAND that use other terms, such as virtual address, to identify the addresses provided by RDMA operations. Flow begins at block 902.

At block 902, the I/O adapter 306 receives an RDMA request from an application program 358 via the SQ 372 all of FIG. 3. The RDMA request specifies an identifier of the memory region 322 from or to which the data will be transferred by the I/O adapter 306, such as an iWARP STag or INFINIBAND memory region handle, which serves as an index into the MRT 382. The RDMA request also includes a tagged offset (TO) that specifies the first byte of data to be transferred, and the length of the data to be transferred. Whether the TO is a zero-based or virtual address-based TO, it is nonetheless a virtual address because it specifies a location of data within a virtually contiguous memory region 322. That is, even if the memory region 322 is backed by discontiguous physical memory pages 324 such that there are discontinuities in the physical memory addresses of the various locations within the memory region 322, namely at page boundaries, there are no discontinuities within a memory region 322 specified in an RDMA request. Flow proceeds to block 904.

At block 904, the I/O controller 308 reads the MRTE 352 indexed by the memory region identifier and examines the PT_Required bit 612 and the Two_Level_PT bit 614 to determine the memory registration level type for the memory region 322. Flow proceeds to decision block 905.

At block 905, the I/O adapter 306 calculates an effective first byte offset (EFBO) using the TO received at block 902 and the translation information stored by the I/O adapter 306 in the MRTE 352 in response to a previous memory registration request 334, as described with respect to the previous Figures, and in particular with respect to FIGS. 3, and 6 through 8. The EFBO 1008 is the offset from the beginning of the first, or beginning, physical memory page 324 of the memory region 322 of the first byte of data to be transferred by the RDMA operation. The EFBO 1008 is employed by the protocol engine 314 as an operand to calculate the final physical address 1012, as described below. If the Zero_Based bit 624 indicates the memory region 322 is zero-based, then as shown in FIG. 9 the EFBO 1008 is calculated according to equation (1) below. If the Zero_Based bit 624 indicates the memory region 322 is virtual address-based, then as shown in FIG. 9 the EFBO 1008 is calculated according to equation (2) below.
EFBO(zero-based)=FBO+TO (1)
EFBO(VA-based)=FBO+(TO−Base_{—}VA) (2)
In an alternate embodiment, if the Zero_Based bit 624 indicates the memory region 322 is virtual address-based, then the EFBO 1008 is calculated according to equation (3) below.
EFBO(VA-based)=TO−(Base_{—}VA & (˜(Page_Size−1))) (3)
As noted above with respect to FIG. 6, the Base_VA value is stored in the Base_VA field 626 of the MRTE 352 if the Zero_Based bit 624 indicates the memory region 322 is VA-based; the FBO value is stored in the FBO field 628 of the MRTE 352; and the Page_Size field 606 indicates the size of a host physical memory page 324. As shown in FIG. 10, the EFBO 1008 may include a byte offset portion 1002, a page table index portion 1004, and a directory index portion 1006, as shown in FIG. 10. FIG. 10 illustrates an example in which the physical memory page 324 size is 4 KB. However, it should be understood that the I/O adapter 306 is configured to accommodate variable physical memory page 324 sizes specified by the memory registration request 334. In the case of a one-level or two-level scheme (i.e., that employs page tables 336, as indicated by the PT_Required bit 612 being set), the byte offset bits 1002 are EFBO 1008 bits [11:0]. However, in the case of a zero-level scheme (i.e., in which the physical page address 332 is stored directly in the MRTE 352 Address 604, as indicated by the PT_Required bit 612 being clear), the byte offset bits 1002 are EFBO 1008 bits [63:0]. In the case of a one-level small page table 336 memory region 322, the page table index bits 1004 are EFBO 1008 bits [16:12], as shown in FIG. 10B. In the case of a one-level large page table 336 or two-level memory region 322, the page table index bits 1004 are EFBO 1008 bits [20:12], as shown in FIGS. 10C and 10D. In the case of a two-level memory region 322, the directory table index bits 1006 are EFBO 1008 bits [30:21], as shown in FIG. 10D. In one embodiment, each PDE 348 is a 32-bit base address of a page table 336, which enables a 4 KB page directory 338 to store 1024 PDEs 348, thus requiring 10 bits of directory table index bits 1006. Flow proceeds to decision block 906.

At decision block 906, the I/O controller 308 determines whether the level type is zero, i.e., whether the PT_Required bit 612 is clear. If so, flow proceeds to block 908; otherwise, flow proceeds to decision block 912.

At block 908, the I/O controller 308 already has the physical page address 332 from the Address 604 of the MRTE 352, and therefore advantageously need not make another access to the I/O adapter memory 316. That is, with a zero-level memory registration, the I/O controller 308 must make no additional accesses to the I/O adapter memory 316 beyond the MRTE 352 access to translate the TO into the physical address 1012. The I/O controller 308 adds the physical page address 332 to the byte offset bits 1002 of the EFBO 1008 to calculate the translated physical address 1012, as shown in FIG. 10A. Flow ends at block 908.

At decision block 912, the I/O controller 308 determines whether the level type is one, i.e., whether the PT_Required bit 612 is set and the Two_Level_PT bit 614 is clear. If so, flow proceeds to block 914; otherwise, the level type is two (i.e., the PT_Required bit 612 is set and the Two_Level_PT bit 614 is set), and flow proceeds to block 922.

At block 914, the I/O controller 308 calculates the address of the appropriate PTE 346 by adding the MRTE 352 Address 604 to the page table index bits 1004 of the EFBO 1008, as shown in FIGS. 10B and 10C. Flow proceeds to block 916.

At block 916, the I/O controller 308 reads the PTE 346 specified by the address calculated at block 914 to obtain the physical page address 332, as shown in FIGS. 10B and 10C. Flow proceeds to block 918.

At block 918, the I/O controller 308 adds the physical page address 332 to the byte offset bits 1002 of the EFBO 1008 to calculate the translated physical address 1012, as shown in FIGS. 10B and 10C. Thus, with a one-level memory registration, the I/O controller 308 is required to make only one additional access to the I/O adapter memory 316 beyond the MRTE 352 access to translate the TO into the physical address 1012. Flow ends at block 918.

At block 922, the I/O controller 308 calculates the address of the appropriate PDE 348 by adding the MRTE 352 Address 604 to the directory table index bits 1006 of the EFBO 1008, as shown in FIG. 10D. Flow proceeds to block 924.

At block 924, the I/O controller 308 reads the PDE 348 specified by the address calculated at block 922 to obtain the base address of a page table 336, as shown in FIG. 10D. Flow proceeds to block 926.

At block 926, the I/O controller 308 calculates the address of the appropriate PTE 346 by adding the address read from the PDE 348 at block 924 to the page table index bits 1004 of the EFBO 1008, as shown in FIG. 10D. Flow proceeds to block 928.

At block 928, the I/O controller 308 reads the PTE 346 specified by the address calculated at block 926 to obtain the physical page address 332, as shown in FIG. 10D. Flow proceeds to block 932.

At block 932, the I/O controller 308 adds the physical page address 332 to the byte offset bits 1002 of the EFBO 1008 to calculate the translated physical address 1012; as shown in FIG. 10D. Thus, with a two-level memory registration, the I/O controller; 308 must make two accesses to the I/O adapter memory 316 beyond the MRTE 352 access to translate the TO into the physical address 1012. Flow ends at block 932.

After the I/O adapter 306 translates the TO into the physical address 1012, it may begin to perform the data transfer specified by the RDMA request. It should be understood that as the I/O adapter 306 sequentially performs the transfer of the data specified by the RDMA request, if the length of the data transfer is such that as the transfer progresses it reaches physical memory page 324 boundaries, in the case of a one-level or two-level memory region 322, the I/O adapter 306 must perform the operation described in FIGS. 9 and 10 again to generate a new physical address 1012 at each physical memory page 324 boundary. However, advantageously, in the case of a zero-level memory region 322, the I/O adapter 306 need not perform the operation described in FIGS. 9 and 10 again. In one embodiment, the RDMA request includes a scatter/gather list, and each element in the scatter/gather list contains an STag or memory region handle, TO, and length, and the I/O adapter 306 must perform the steps described in FIG. 9 one or more times for each scatter/gather list element. In one embodiment, the protocol engine 314 includes one or more DMA engines that handle the scatter/gather list processing and page boundary crossing.

Although not shown in FIG. 10, a two-level small page table 336 embodiment is contemplated. That is, the page directory 338 is a small page directory 338 of 256 bytes (which provides 64 PDEs 348 since each PDE 348 only requires four bytes in one embodiment) and each of up to 32 page tables 336 is a small page table 336 of 256 bytes (which provides 32 PTEs 346 since each PTE 346 requires eight bytes). In this embodiment, the steps at blocks 922 through 932 are performed to do the address translation. Furthermore, other two-level embodiments are contemplated comprising a small page directory 338 pointing to large page tables 336, and a large page directory 338 pointing to small page tables 336.

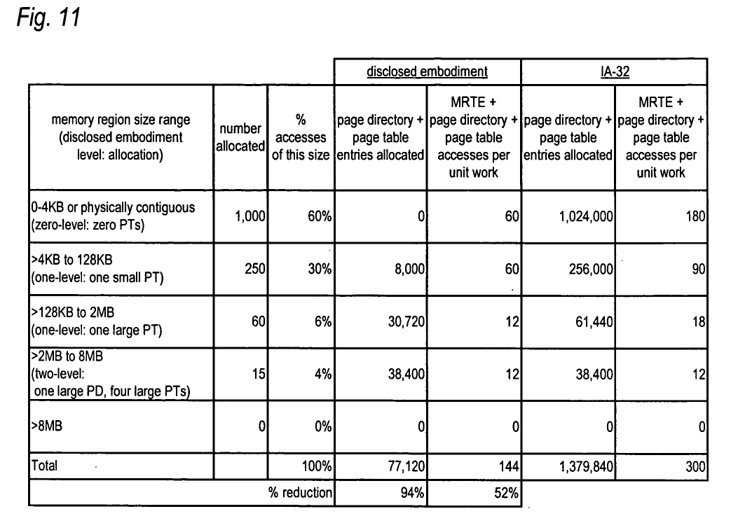

Referring now to FIG. 11, a table comparing, by way of example, the amount of I/O adapter memory 316 allocation and I/O adapter memory 316 accesses that would be required by the I/O adapter 306 employing the memory management method described herein according to the present invention with an I/O adapter employing a conventional IA-32 memory management method is shown. The table attempts to make the comparison by using an example in which five different memory region 322 size ranges are selected, namely: 0-4 KB or physically contiguous, greater than 4 KB but less than or equal to 128 KB, greater than 128 KB but less than or equal to 2 MB, greater than 2 MB but less than or equal to 8 MB, and greater than 8 MB. Furthermore, it is assumed that the mix of memory regions 322 allocated at a time for the five respective size ranges is: 1,000, 250, 60, 15, and 0. Finally, it is assumed that accesses by the I/O adapter 306 to the memory regions 322 for the five size ranges selected are made according to the following respective percentages: 60%, 30%, 6%, 4%, and 0%. Thus, as may be observed, it is assumed that no memory regions 322 greater than 8 MB will be registered and that, generally speaking, application programs 358 are likely to register more memory regions 322 of smaller size and that application programs 358 are likely to issue RDMA operations that access smaller size memory regions 322 more frequently than larger size memory regions 322. The table of FIG. 11 also assumes 4 KB physical memory pages 324, small page tables 336 of 256 bytes (32 PTEs), and large page tables 336 of 4 KB (512 PTEs). It should be understood that the values chosen in the example are not intended to represent experimentally determined values and are not intended to represent a particular application program 358 usage, but rather are chosen as a hypothetical example for illustration purposes.

As shown in FIG. 11, for both the present invention and the conventional IA-32 scheme described above, the number of PDEs 348 and PTEs 346 that must be allocated for each memory region 322 size range is calculated given the assumptions of number of memory regions 322 and percent I/O adapter memory 316 accesses for each memory region 322 size range. For the conventional IA-32 method, one page directory (512 PDEs) and one page table (512 PTEs) are allocated for each of the ranges except the 2 MB to 8 MB range, which requires one page directory (512 PDEs) and four page tables (2048 PTEs). For the embodiment of the present invention, in the 0-4 KB range, zero page directories 338 and page tables 336 are allocated; in the 4 KB to 128 KB range, one small page table 336 (32 PTEs) is allocated; in the 128 KB to 2 MB range, one large page table 336 (512 PTEs) is allocated; and in the 2 MB to 8 MB range, one large page directory 338 (512 PTEs) plus four large page tables 336 (2048 PTEs) are allocated.

In addition, the number of accesses per unit work to a PDE 348 or PTE 346 is calculated given the assumptions of number of memory regions 322 and percent accesses for each memory region 322 size range. A unit work is the processing required to translate one virtual address to one physical address; thus, for example, each scatter/gather element requires at least one unit work, and each page boundary encountered requires another unit work, except advantageously in the zero-level case of the present invention as described above. The values are given per 100. For the conventional IA-32 method, each unit work requires three accesses to I/O adapter memory 316: one to an MRTE 352, one to a page directory 338, and one to a page table 336. In contrast, for the present invention, in the zero-level category, each unit work requires only one access to I/O adapter memory 316: one to an MRTE 352; in the one-level categories, each unit work requires two accesses to I/O adapter memory 316: one to an MRTE 352 and one to a page table 336; in the two-level category, each unit work requires three accesses to I/O adapter memory 316: one to a page directory 338, and one to a page table 336.

As shown in the table, the number of PDE/PTEs is reduced from 1,379,840 (10.5 MB) to 77,120 (602.5 KB), which is a 94% reduction by the present invention over the conventional IA-32 method based on the values chosen in the example. Also as shown, the number of accesses per unit work to an MRTE 352, PDE 348, or PTE 346 is reduced from 300 to 144, which is a 52% reduction by the present invention over the conventional IA-32 method based on the values chosen in the example, thereby reducing the bandwidth of the I/O adapter memory 316 consumed and reducing RDMA latency. Thus, it may be observed that the embodiments of the memory management method described herein advantageously potentially significantly reduce the amount of I/O adapter memory 316 required and therefore the cost of the I/O adapter 306 in the presence of relatively small and relatively frequently registered memory regions. Additionally, the embodiments advantageously potentially reduce the average amount of I/O adapter memory 316 bandwidth consumed and the latency required to perform a memory translation in response to an RDMA request.

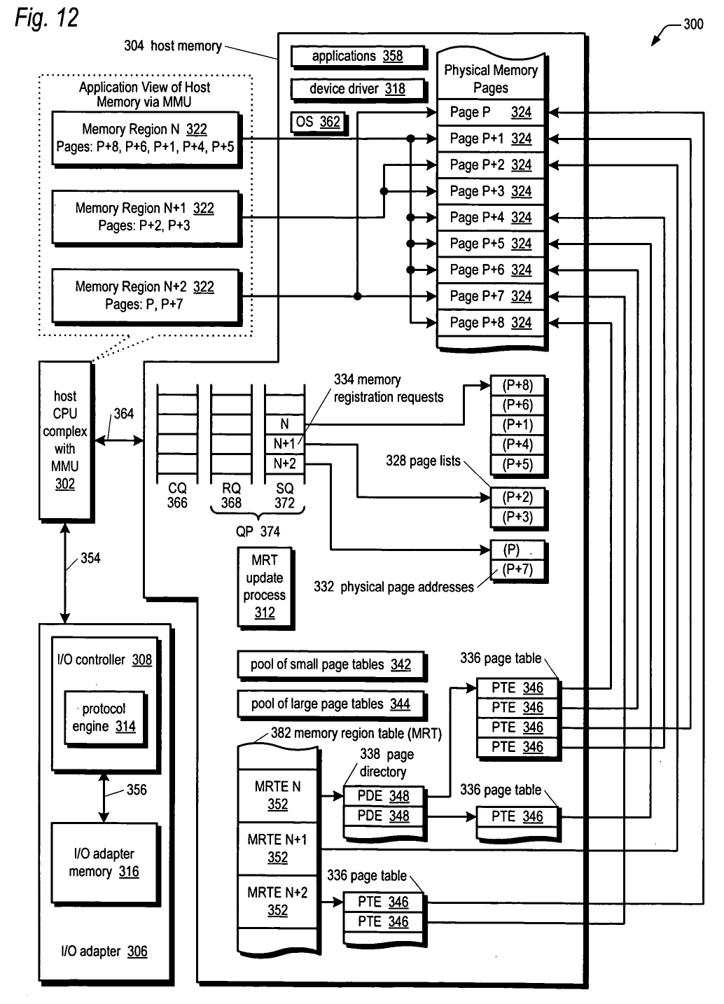

Referring now to FIG. 12, a block diagram illustrating a computer system 300 according to an alternate embodiment of the present invention is shown. The system 300 is similar to the system 300 of FIG. 3; however, the address translation data structures (pool of small page tables 342, pool of large page tables 344, MRT 322, PTEs 346, and PDEs 348) are stored in the host memory 304 rather than the I/O adapter memory 316. Additionally, the MRT update process 312 may be incorporated into the device driver 318 and executed by the CPU complex 302 rather than the I/O adapter 306 control processor 406, and is therefore stored in host memory 304. Hence, with the embodiment of FIG. 12, the device driver 318 creates the address translation data structures in the host memory 304 rather than commanding the I/O adapter 306 to do so as described with respect to FIG. 5. Additionally, with the embodiment of FIG. 12, the device driver 318 allocates the address translation data structures in the host memory 304 rather than commanding the I/O adapter 306 to do so as described with respect to FIG. 7. Still further, with the embodiment of FIG. 12, the I/O adapter 306 accesses the address translation data structures in the host memory 304 rather than the I/O adapter memory 316 as described with respect to FIG. 9.

The advantage of the embodiment of FIG. 12 is that it potentially enables the I/O adapter 306 to have a smaller I/O adapter memory 316 by using the host memory 304 to store the address translation data structures. The advantage may be realized in exchange for potentially slower accesses to the address translation data structures in the host memory 304 when performing address translation, such as in processing RDMA requests. However, the slower accesses may potentially be ameliorated by the I/O adapter 306 caching the address translation data structures. Nevertheless, employing the various selective zero-level, one-level, and two-level schemes and multiple page table 336 size schemes described herein for storage of the address translation data structures in host memory 304 has the advantage of reducing the amount of host memory 304 required to store the address translation data structures over a conventional scheme, such as employing the full two-level IA-32-style set of page directory/page table resources scheme. Finally, an embodiment is contemplated in which the MRT 382 resides in the I/O adapter memory 316 and the page tables 336 and page directories 338 reside in the host memory 304.

Although the present invention and its objects, features, and advantages have been described in detail, other embodiments are encompassed by the invention. For example, although embodiments have been described in which the device driver performs the steps to determine the number of levels of page tables required to describe a memory region and performs the steps to determine which size page table to use, the I/O adapter could perform some or all of these steps rather than the device driver. Furthermore, although an embodiment has been described in which the number of different sizes of page tables is two, other embodiments are contemplated in which the number of different sizes of page tables is greater than two. Additionally, although embodiments have been described with respect to memory regions, the I/O adapter is also configured to support memory management of subsets of memory regions, including but not limited to, memory windows such as those defined by the iWARP and INIFINIBAND specifications.

Still further, although embodiments have been described in which a single host CPU complex with a single operating system is accessing the I/O adapter, other embodiments are contemplated in which the I/O adapter is accessible by multiple operating systems within a single CPU complex via server virtualization enabled by, for example, VMware (see www.vmware.com) or Xen (see www.xensource.com), or by multiple host CPU complexes each executing its own one or more operating systems enabled by work underway in the PCI SIG I/O Virtualization work group. In these virtualization embodiments, the I/O adapter may translate virtual addresses into physical addresses, and/or physical addresses into machine addresses, and/or virtual addresses into machine addresses, as defined for example by the aforementioned virtualization embodiments, in a manner similar to the translation of virtual to physical addresses described above. In a virtualization context, the term “machine address,” rather than “physical address,” is used to refer to the actual hardware memory address. In the server virtualization context, for example, when a CPU complex is hosting multiple operating systems, three types of address space are defined: the term virtual address is used to refer to an address used by application programs running on the operating systems similar to a non-virtualized server context; the term physical address, which is in reality a pseudo-physical address, is used to refer to an address used by the operating systems to access what they falsely believe are actual hardware resources such as host memory; the term machine address is used to refer to an actual hardware address that has been translated from an operating system physical address by the virtualization software, commonly referred to as a Hypervisor. Thus, the operating system views its physical address space as a contiguous set of physical memory pages in a physically contiguous address space, and allocates subsets of the physical memory pages, which may be physically discontiguous subsets, to the application program to back the application program's contiguous virtual address space; similarly, the Hypervisor views its machine address space as a contiguous set of machine memory pages in a machine contiguous address space, and allocates subsets of the machine memory pages, which may be machine discontiguous subsets, to the operating system to back what the operating system views as a contiguous physical address space. The salient point is that the I/O adapter is required to perform address translation for a virtually contiguous memory region in which the to-be-translated addresses (i.e., the input addresses to the I/O adapter address translation process, which are typically referred to in the virtualization context as either virtual or physical addresses) specify locations in a virtually contiguous address space, i.e., the address space appears contiguous to the user of the address space—whether the user is an application program or an operating system or address translating hardware, and the translated-to addresses (i.e., the output addresses from the I/O adapter address translation process, which are typically referred to in the virtualization context as either physical or machine addresses) specify locations in potentially discontiguous physical memory pages. Advantageously, the address translation schemes described herein may be employed in the virtualization contexts to achieve the advantages described, such as reduced memory space and bandwidth consumption and reduced latency. The embodiments may be thus advantageously employed in I/O adapters that do not service RDMA requests, but are still required to perform virtual-to-physical and/or physical-to-machine and/or virtual-to-machine address translations based on address translation information about a memory region registered with the I/O adapter.

While various embodiments of the present invention have been described above, it should be understood that they have been presented by way of example, and not limitation. It will be apparent to persons skilled in the relevant computer arts that various changes in form and detail can be made therein without departing from the scope of the invention. Thus, the present invention should not be limited by any of the above-described exemplary embodiments, but should be defined only in accordance with the following claims and their equivalents.

We claim:

1. A method for performing memory registration for an I/O adapter having a memory, the method comprising:
creating a first pool of a first type of page table and a second pool of a second type of page table within the I/O adapter memory, wherein said first type of page table includes storage for a first predetermined number of entries each for storing a physical page address, wherein said second type of page table includes storage for a second predetermined number of entries each for storing a physical page address, wherein said second predetermined number of entries is greater than said first predetermined number of entries; and
in response to receiving a memory registration request specifying physical page addresses of a number of physical memory pages backing a virtually contiguous memory region:
allocating one of said first type of page table for storing said physical page addresses, if said number of physical memory pages is less than or equal to said first predetermined number of entries; and
allocating one of said second type of page table for storing said physical page addresses, if said number of physical memory pages is greater than said first predetermined number of entries and less than or equal to said second predetermined number of entries.

2. The method as recited in claim 1, further comprising:
in response to receiving said memory registration request:
allocating a plurality of page tables within the I/O adapter memory, if said number of physical memory pages is greater than said second predetermined number of entries, wherein a first of said plurality of page tables is used for storing pointers to remaining ones of said plurality of page tables, wherein said remaining ones of said plurality of page tables are used for storing said physical page addresses.

3. The method as recited in claim 2, further comprising:
allocating zero page tables, if all of said physical memory pages are physically contiguous, and instead storing said physical page address of a first of said physical memory pages in a memory region table entry allocated to said memory region in response to said receiving said memory registration request.

4. The method as recited in claim 2, wherein said allocating a plurality of page tables comprises allocating a plurality of said first type of page tables.

5. The method as recited in claim 2, wherein said allocating a plurality of page tables comprises allocating a plurality of said second type of page tables.

6. The method as recited in claim 2, wherein said first of said plurality of page tables is of said second type, wherein said remaining ones of said plurality of page tables are of said first type.

7. The method as recited in claim 2, wherein said first of said plurality of page tables is of said first type, wherein said remaining ones of said plurality of page tables are of said second type.

8. The method as recited in claim 1, wherein said first of said plurality of page tables comprises a page directory.

9. The method as recited in claim 1, further comprising:
allocating zero page tables, if all of said physical memory pages are physically contiguous, and instead storing said physical page address of a first of said physical memory pages in a memory region table entry allocated to said memory region in response to said receiving said memory registration request.

10. The method as recited in claim 9, further comprising:
allocating a plurality of page tables within the I/O adapter memory, if all of said physical memory pages are not physically contiguous and if said number of physical memory pages is greater than said second predetermined number of entries, wherein a first of said plurality of page tables is used for storing pointers to remaining ones of said plurality of page tables, wherein said remaining ones of said plurality of page tables are used for storing said physical page addresses.

11. The method as recited in claim 10, wherein said allocating a plurality of page tables comprises allocating a plurality of said second type of page tables.

12. The method as recited in claim 10, wherein said allocating a plurality of page tables comprises allocating a plurality of said first type of page tables.

13. The method as recited in claim 10, wherein said first of said plurality of page tables is of said first type, wherein said remaining ones of said plurality of page tables are of said second type.

14. The method as recited in claim 10, wherein said first of said plurality of page tables is of said second type, wherein said remaining ones of said plurality of page tables are of said first type.

15. The method as recited in claim 1, further comprising:
configuring said first pool to have a first number of said first type of page tables and configuring said second pool to have a second number of said second type of page tables, prior to said creating said first and second pools.

16. The method as recited in claim 1, further comprising:
configuring said first and second predetermined number of entries, prior to said creating said first and second pools.

17. The method as recited in claim 16, wherein said first predetermined number of entries is 32 and said second predetermined number of entries is 512.

18. The method as recited in claim 1, wherein said memory registration request comprises an iWARP Register Non-Shared Memory Region Verb.

19. The method as recited in claim 1, wherein said memory registration request comprises an Infiniband Register Memory Region Verb.

20. The method as recited in claim 1, wherein said I/O adapter comprises an RDMA-enabled I/O adapter.

21. The method as recited in claim 20, wherein said RDMA-enabled I/O adapter comprises an RDMA-enabled network interface adapter.

22. The method as recited in claim 21, wherein said RDMA-enabled network interface adapter comprises an RDMA-enabled Ethernet adapter.

23. The method as recited in claim 1, wherein said number of physical memory pages may be 1.

24. A method for registering a virtually contiguous memory region with an I/O adapter, the memory region comprising a virtually contiguous memory range implicating a plurality of physical memory pages in a host computer coupled to the I/O adapter, the I/O adapter having a memory, the method comprising:
receiving a memory registration request, the request comprising a list specifying a physical page address of each of the plurality of physical memory pages;
allocating an entry in a memory region table of the I/O adapter memory for the memory region, in response to said receiving the memory registration request;
determining whether the plurality of physical memory pages are physically contiguous based on the list of physical page addresses; and
if the plurality of physical memory pages are physically contiguous:
forgoing allocating any page tables for the memory region; and
storing a physical page address of a beginning physical memory page of the plurality of physical memory pages into the memory region table entry.

25. The method as recited in claim 24, further comprising:
if the plurality of physical memory pages are not physically contiguous:
determining whether the plurality of physical memory pages is less than or equal to a number of entries in one page table; and
if the plurality of physical memory pages is less than or equal to the number of entries in one page table:
allocating one page table in the I/O adapter memory, for storing the list of physical page addresses; and
storing an address of the one page table into the memory region table entry.

26. The method as recited in claim 25, further comprising:
if the plurality of physical memory pages are not physically contiguous:
if the plurality of physical memory pages is not less than or equal to the number of entries in one page table:
allocating a plurality of page tables in the I/O adapter memory, each for storing a portion of the list of physical page addresses;
allocating a page directory in the I/O adapter memory, for storing the addresses of the plurality of page tables; and
storing an address of the page directory into the memory region table entry.

27. The method as recited in claim 24, further comprising:
creating a first pool of a first type of page table and a second pool of a second type of page table within the I/O adapter memory, prior to said receiving the memory registration request, wherein the first type of page table includes storage for a first predetermined number of entries each for storing a physical page address, wherein the second type of page table includes storage for a second predetermined number of entries each for storing a physical page address, wherein the second predetermined number of entries is greater than the first predetermined number of entries;
if the plurality of physical memory pages are not physically contiguous:
determining whether the plurality of physical memory pages is less than or equal to a number of entries in one of the first type of page table;
if the plurality of physical memory pages is less than or equal to the number of entries in one of the first type of page table:
allocating one of the first type of page table in the I/O adapter memory, for storing the list of physical page addresses; and
storing an address of the one of the first type of page table into the memory region table entry.

28. The method as recited in claim 27, further comprising:
if the plurality of physical memory pages are not physically contiguous:
if the plurality of physical memory pages is not less than or equal to the number of entries in one of the first type of page table:
determining whether the plurality of physical memory pages is less than or equal to a number of entries in one of the second type of page table;
if the plurality of physical memory pages is less than or equal to the number of entries in one of the second type of page table:
allocating one of the second type of page table in the I/O adapter memory, for storing the list of physical page addresses; and
storing an address of the one of the second type of page table into the memory region table entry.

29. The method as recited in claim 28, further comprising:
if the plurality of physical memory pages are not physically contiguous:
if the plurality of physical memory pages is not less than or equal to the number of entries in one of the first type of page table:
if the plurality of physical memory pages is not less than or equal to the number of entries in one of the second type of page table:
allocating a plurality of page tables in the I/O adapter memory, each for storing a portion of the list of physical page addresses;
allocating a page directory in the I/O adapter memory, for storing the addresses of the plurality of page tables; and
storing an address of the page directory into the memory region table entry.

30. The method as recited in claim 29, wherein the plurality of page tables comprises a plurality of page tables of the second type.

31. The method as recited in claim 29, wherein the plurality of page tables comprises a plurality of page tables of the first type.

32. The method as recited in claim 29, wherein the page directory comprises a page table of the first type.

33. The method as recited in claim 29, wherein the page directory comprises a page table of the second type.

34. The method as recited in claim 27, further comprising:
receiving a command specifying the first and second predetermined number of entries, prior to said creating the first and second pool.

35. The method as recited in claim 27, further comprising:
receiving a command specifying a first number of the first type of page tables in the first pool and a second number of the second type of page tables in the second pool, prior to said creating the first and second pool.

36. An I/O adapter for interfacing a host computer to a transport medium, the host computer having a memory for storing virtually contiguous memory regions, each backed by a plurality of physical memory pages, the memory regions having been previously registered with the I/O adapter, the I/O adapter comprising:
a memory, for storing a memory region table, said table comprising a plurality of entries, each configured to store an address and an indicator associated with one of the virtually contiguous memory regions, wherein said indicator indicates whether the plurality of memory pages backing said memory region are physically contiguous; and
a protocol engine, coupled to said memory region table, configured:
to receive from the host computer a request to transfer data between the transport medium and a location specified by a virtual address within said memory region associated with one of said plurality of table entries, wherein said virtual address is specified by said data transfer request; and
to read said table entry associated with said memory region, in response to receiving said request;
wherein if said indicator indicates the plurality of memory pages are physically contiguous, said memory region table entry address is a physical page address of one of the plurality of memory pages that includes said location specified by said virtual address.

37. The I/O adapter as recited in claim 36, wherein said protocol engine is further configured:
to generate a first offset based on said virtual address and based on a second offset, wherein said first offset specifies said location specified by said virtual address relative to a beginning page of the plurality of memory pages of said memory region, wherein said second offset specifies a location of a first byte of said memory region relative to said beginning page of the plurality of memory pages of said memory region;
to translate said virtual address into a physical address of said location specified by said virtual address by adding said first offset to said physical page address read from said memory region table entry address.

38. The I/O adapter as recited in claim 37, wherein said protocol engine is configured to generate said first offset by adding said virtual address to said second offset.

39. The I/O adapter as recited in claim 37, wherein said protocol engine is configured to generate said first offset by adding said virtual address minus a second virtual address to said second offset, wherein said second virtual address specifies said location of said first byte of said memory region.

40. The I/O adapter as recited in claim 36, wherein said adapter memory is further configured to store a plurality of page tables, wherein each of said plurality of entries of said memory region table are further configured to store a second indicator for indicating whether said memory region table entry address points to one of said plurality of page tables, wherein if said first indicator indicates the plurality of memory pages are not physically contiguous and if said second indicator indicates said memory region table entry address points to one of said plurality of page tables, said protocol engine is further configured:
to read an entry of one of said plurality of page tables to obtain said physical page address of said one of the plurality of memory pages that includes said location specified by said virtual address, wherein said one of said plurality of page tables is pointed to by said memory region table entry address.

41. The I/O adapter as recited in claim 40, wherein if said first indicator indicates the plurality of memory pages are not physically contiguous and if said second indicator indicates said memory region table entry address points to one of said plurality of page tables, said protocol engine is further configured:
to generate a first offset based on said virtual address and based on a second offset, wherein said first offset specifies said location specified by said virtual address relative to a beginning page of the plurality of memory pages of said memory region, wherein said second offset specifies a location of a first byte of said memory region relative to said beginning page of the plurality of memory pages of said memory region; and
to translate said virtual address into a physical address of said location specified by said virtual address by adding a lower portion of said first offset to said physical page address read from said entry of said one of said plurality of page tables.

42. The I/O adapter as recited in claim 41, wherein said protocol engine is further configured to determine a location of said entry of said one of said plurality of page tables by adding a middle portion of said first offset to said address read from said memory region table entry.

43. The I/O adapter as recited in claim 42, wherein each of said plurality of entries of said memory region table is further configured to store a third indicator for indicating whether said plurality of page tables comprise a first or second predetermined number of entries, wherein said middle portion of said first offset comprises a first predetermined number of bits if said third indicator indicates said plurality of page tables comprise said first predetermined number of entries, and said middle portion of said first offset comprises a second predetermined number of bits if said third indicator indicates said plurality of page tables comprise said second predetermined number of entries.

44. The I/O adapter as recited in claim 40, wherein said adapter memory is further configured to store a plurality of page directories, wherein if said first indicator indicates the plurality of memory pages are not physically contiguous and if said second indicator indicates said memory region table entry address does not point to one of said plurality of page tables, said protocol engine is further configured:
to read an entry of one of said plurality of page directories to obtain a base address of a second of said plurality of page tables, wherein said one of said plurality of page directories is pointed to by said memory region table entry address; and
to read an entry of said second of said plurality of page tables to obtain said physical page address of said one of the plurality of memory pages that includes said location specified by said virtual address.

45. The I/O adapter as recited in claim 44, wherein if said first indicator indicates the plurality of memory pages are not physically contiguous and if said second indicator indicates said memory region table entry address does not point to one of said plurality of page tables, said protocol engine is further configured:
to generate a first offset based on said virtual address and based on a second offset, wherein said first offset specifies said location specified by said virtual address relative to a beginning page of the plurality of memory pages of said memory region, wherein said second offset specifies a location of a first byte of said memory region relative to said beginning page of the plurality of memory pages of said memory region; and
to translate said virtual address into a physical address of said location specified by said virtual address by adding a lower portion of said first offset to said physical page address read from said entry of said second of said plurality of page tables.

46. The I/O adapter as recited in claim 45, wherein said protocol engine is further configured to determine a location of said entry of said one of said plurality of page directories by adding an upper portion of said first offset to said address read from said memory region table entry.

47. The I/O adapter as recited in claim 46, wherein said protocol engine is further configured to determine a location of said entry of said second of said plurality of page tables by adding a middle portion of said first offset to said base address of said second of said plurality of page tables read from said page directory entry.

48. The I/O adapter as recited in claim 36, wherein said request to transfer data comprises an RDMA request.

49. The I/O adapter as recited in claim 48, wherein said RDMA request comprises an iWARP RDMA request.

50. The I/O adapter as recited in claim 48, wherein said RDMA request comprises an INFINIBAND RDMA request.

51. An I/O adapter for interfacing a host computer to a transport medium, the host computer having a memory, the I/O adapter comprising:
a memory region table, comprising a plurality of entries, each configured to store an address and a level indicator associated with a virtually contiguous memory region; and
a protocol engine, coupled to said memory region table, configured to receive from the host computer a request to transfer data between the transport medium and a virtual address in a memory region in the host memory associated with an entry in said memory region table, responsively read said memory region table entry, and examine said entry level indicator;
wherein if said level indicator indicates two levels, said protocol engine is configured to:
read an address of a page table from an entry in a page directory, wherein said entry within said page directory is specified by a first index comprising a first portion of said virtual address, wherein an address of said page directory is specified by said memory region table entry address; and
read a physical page address of a physical memory page backing said virtual address from an entry in said page table, wherein said entry within said page table is specified by a second index comprising a second portion of said virtual address;
wherein if said level indicator indicates one level, said protocol engine is configured to:
read said physical page address of said physical memory page backing said virtual address from an entry in a page table, wherein said entry within said page table is specified by said second index comprising said second portion of said virtual address, wherein an address of said page table is specified by said memory region table entry address.

52. The I/O adapter as recited in claim 51, wherein if said level indicator indicates zero levels, said physical page address of said physical memory page backing said virtual address is said memory region table entry address.

53. The I/O adapter as recited in claim 51, wherein said memory region table is indexed by an iWARP STag.

54. The I/O adapter as recited in claim 51, wherein said transport medium comprises an Ethernet transport medium.

55. The I/O adapter as recited in claim 51, wherein said request to transfer data comprises an RDMA request.

56. An RDMA-enabled I/O adapter for interfacing a host computer to a transport medium, the host computer having a host memory, the I/O adapter comprising:
a memory region table, comprising a plurality of entries, each configured to store information describing a virtually contiguous memory region; and
a protocol engine, coupled to said memory region table, configured to receive first, second, and third RDMA requests specifying respective first, second, and third virtual addresses in respective first, second, and third memory regions described in respective first, second, and third of said plurality of memory region table entries;
wherein in response to said first RDMA request, said protocol engine is configured to read said first entry to obtain a physical page address specifying a first physical memory page backing said first virtual address;
wherein in response to said second RDMA request, said protocol engine is configured to read said second entry to obtain an address of a first page table, and to read an entry in said first page table indexed by a first portion of bits of said virtual address to obtain a physical page address specifying a second physical memory page backing said second virtual address; and
wherein in response to said third RDMA request, said protocol engine is configured to read said third entry to obtain an address of a page directory, to read an entry in said page directory indexed by a second portion of bits of said virtual address to obtain an address of a second page table, and to read an entry in said second page table indexed by said first portion of bits of said virtual address to obtain a physical page address specifying a third physical memory page backing said third virtual address.

57. The I/O adapter as recited in claim 56, wherein said protocol engine is further configured to add a third portion of bits of said virtual address to said physical page address of said first, second, and third physical memory pages to obtain respective translated physical addresses of said first, second, and third virtual addresses.

58. The I/O adapter as recited in claim 56, wherein said plurality of memory region table entries are each further configured to store an indication of whether said entry stores a physical page address, an address of a page table, or an address of a page directory.

59. The I/O adapter as recited in claim 56, wherein said first, second, and third RDMA requests each specify an index into said respective first, second, and third of said plurality of memory region table entries.

60. An I/O adapter for interfacing a host computer to a transport medium, the host computer having a memory for storing a virtually contiguous memory region backed by a plurality of physical memory pages, the memory region having been previously registered with the I/O adapter, the I/O adapter comprising:
a memory, for storing address translation information for use by the adapter to translate a virtual address to a physical address of a location within the memory region, wherein said address translation information is stored in said memory in response to the previous registration of the memory region; and
a protocol engine, coupled to said memory, configured to perform only one access to said memory to fetch a portion of said address translation information to translate said virtual address to said physical address, if the plurality of physical memory pages are physically contiguous.

61. The I/O adapter as recited in claim 60, wherein if the plurality of physical memory pages are not physically contiguous, said protocol engine is further configured to perform only two accesses to said memory to fetch a portion of said address translation information to translate said virtual address to said physical address, if the plurality of physical memory pages are not greater than a predetermined number.

62. The I/O adapter as recited in claim 61, wherein if the plurality of physical memory pages are not physically contiguous, said protocol engine is further configured to perform only three accesses to said memory to fetch a portion of said address translation information to translate said virtual address to said physical address, if the plurality of physical memory pages are greater than said predetermined number.

63. The I/O adapter as recited in claim 60, wherein said request to transfer data comprises an RDMA request.

64. An I/O adapter for interfacing a host computer to a transport medium, the host computer having a memory for storing a virtually contiguous memory region backed by a plurality of physical memory pages, the memory region having been previously registered with the I/O adapter, the I/O adapter comprising:
a memory, for storing address translation information for use by the adapter to translate a virtual address to a physical address of a location within the memory region, wherein said address translation information is stored in said memory in response to the previous registration of the memory region; and
a protocol engine, coupled to said memory, configured to perform only two accesses to said memory to fetch a portion of said address translation information to translate said virtual address to said physical address, if the plurality of physical memory pages are not greater than a predetermined number, and to perform only three accesses to said memory to fetch a portion of said address translation information to translate said virtual address to said physical address, if the plurality of physical memory pages are greater than said predetermined number.

65. The I/O adapter as recited in claim 64, wherein if the plurality of physical memory pages are physically contiguous, said protocol engine is configured to perform only one access to said memory to fetch a portion of said address translation information to translate said virtual address to said physical address.

66. The I/O adapter as recited in claim 65, wherein said request to transfer data comprises an RDMA request.

67. A method for performing memory registration for an I/O adapter coupled to a host computer, the host computer having a host memory, the method comprising:
creating a first pool of a first type of page table and a second pool of a second type of page table within the host memory, wherein said first type of page table includes storage for a first predetermined number of entries each for storing a physical page address, wherein said second type of page table includes storage for a second predetermined number of entries each for storing a physical page address, wherein said second predetermined number of entries is greater than said first predetermined number of entries; and
in response to receiving a memory registration request specifying physical page addresses of a number of physical memory pages backing a virtually contiguous memory region:
allocating one of said first type of page table for storing said physical page addresses, if said number of physical memory pages is less than or equal to said first predetermined number of entries; and
allocating one of said second type of page table for storing said physical page addresses, if said number of physical memory pages is greater than said first predetermined number of entries and less than or equal to said second predetermined number of entries.

68. The method as recited in claim 67, further comprising:
in response to receiving said memory registration request:
allocating a plurality of page tables within the host memory, if said number of physical memory pages is greater than said second predetermined number of entries, wherein a first of said plurality of page tables is used for storing pointers to remaining ones of said plurality of page tables, wherein said remaining ones of said plurality of page tables are used for storing said physical page addresses.

69. The method as recited in claim 67, further comprising:
allocating zero page tables, if all of said physical memory pages are physically contiguous, and instead storing said physical page address of a first of said physical memory pages in a memory region table entry allocated to said memory region in response to said receiving said memory registration request.

70. The method as recited in claim 69, wherein said memory region table resides in the host memory.

71. The method as recited in claim 69, wherein said memory region table resides in a memory of the I/O adapter.

72. A method for registering a virtually contiguous memory region with an I/O adapter, the memory region comprising a virtually contiguous memory range implicating a plurality of physical memory pages in a host computer coupled to the I/O adapter, the host computer having a memory comprising the physical memory pages, the method comprising:
receiving a memory registration request, the request comprising a list specifying a physical page address of each of the plurality of physical memory pages;
allocating an entry in a memory region table of the host computer memory for the memory region, in response to said receiving the memory registration request;
determining whether the plurality of physical memory pages are physically contiguous based on the list of physical page addresses; and
if the plurality of physical memory pages are physically contiguous:
forgoing allocating any page tables for the memory region; and
storing a physical page address of a beginning physical memory page of the plurality of physical memory pages into the memory region table entry.

73. The method as recited in claim 72, further comprising:
if the plurality of physical memory pages are not physically contiguous:
determining whether the plurality of physical memory pages is less than or equal to a number of entries in one page table; and
if the plurality of physical memory pages is less than or equal to the number of entries in one page table:
allocating one page table in the host computer memory, for storing the list of physical page addresses; and
storing an address of the one page table into the memory region table entry.

74. The method as recited in claim 73, further comprising:
if the plurality of physical memory pages are not physically contiguous:
if the plurality of physical memory pages is not less than or equal to the number of entries in one page table:
allocating a plurality of page tables in the host computer memory, each for storing a portion of the list of physical page addresses;
allocating a page directory in the host computer memory, for storing the addresses of the plurality of page tables; and
storing an address of the page directory into the memory region table entry.

75. An I/O adapter for interfacing a host computer to a transport medium, the host computer having a memory, the I/O adapter comprising:
a protocol engine, configured to access a memory region table stored in the host computer memory, said table comprising a plurality of entries, each configured to store an address and a level indicator associated with a virtually contiguous memory region;
wherein the protocol engine is further configured to receive from the host computer a request to transfer data between the transport medium and a virtual address in a memory region in the host memory associated with an entry in said memory region table, to responsively read said memory region table entry, and to examine said entry level indicator;
wherein if said level indicator indicates two levels, said protocol engine is configured to:
read an address of a page table from an entry in a page directory, wherein said entry within said page directory is specified by a first index comprising a first portion of said virtual address, wherein an address of said page directory is specified by said memory region table entry address, wherein said page directory and said page table are stored in said host computer memory; and
read a physical page address of a physical memory page backing said virtual address from an entry in said page table, wherein said entry within said page table is specified by a second index comprising a second portion of said virtual address;
wherein if said level indicator indicates one level, said protocol engine is configured to:
read said physical page address of said physical memory page backing said virtual address from an entry in a page table, wherein said entry within said page table is specified by said second index comprising said second portion of said virtual address, wherein an address of said page table is specified by said memory region table entry address, wherein said page table is stored in said host computer memory.

76. The I/O adapter as recited in claim 75, wherein if said level indicator indicates zero levels, said physical page address of said physical memory page backing said virtual address is said memory region table entry address.
